(19) United States
(12) Patent Application Publication
(10) Pub. No.: US 2002/0103737 A1
(43) Pub. Date: Aug. 1, 2002

(54) Marketing collateral repository and supporting data management and communication environment

(76) Inventor: Daniel D. Briere, Mansfield, CT (US)

Correspondence Address: BANNER & WITCOFF, 1001 G STREET N W, SUITE 1100, WASHINGTON, DC, 20001, US

(21) Appl. No.: 09/948,050

(22) Filed: Sep. 7, 2001

Related U.S. Application Data
(60) Provisional application No. 60/230,799, filed on Sep. 7, 2000.

(51) Int. Cl. G06F 17/60

(52) U.S. Cl. 705/36

(57) ABSTRACT

A method and apparatus for collection and dissemination of information in an organized and systematic manner using a one or more computer networks. The information is collected from its originators, sorted and organized in an efficient and searchable manner. The information can then be used by buyers to research and choose the products and services that best fit their needs and wants.

### CROSS-REFERENCE TO RELATED APPLICATION

This application claims priority to U.S. Provisional Application Serial Number No. 60/230,799 file Sep. 7, 2001 and entitled “Marketing Collateral Repository And Supporting Data Management And Communication Environment.”

### BACKGROUND OF THE INVENTION

The present invention generally relates to the field of information technology and more particularly, is directed to a method and apparatus for collection and dissemination of information in an organized and systematic manner using a one or more computer networks.

The World Wide Web's phenomenal success has brought a wealth of options to buyers' computer screens, allowing them to research and choose the products and services that best fit their needs and wants. In fact, so many options exist that searching for a product can easily become daunting. Information is difficult to find, conflicting, incomplete, or simply missing. The novice buyer becomes overwhelmed trying to discern who has what and what is important.

Increasingly, buyers are turning to trusted advisors (referred to herein as, “Influencers”) to guide their purchase decisions. These Influencers come in many forms:

People. Reporters, editors, financial analysts, industry analysts, associations/forums, regulatory bodies, etc.

Web-based Media. Online vertical sites and buyer's guides covering a specific industry or a broad spectrum of technology-based products, directories, links pages, FAQs, comparative Web sites, and search engines.

Other Media. Print publications like magazines and newspapers, radio, and TV shows, such as MSNBC, CNET TV, etc.

Influencers fill a critical role in helping buyers to better understand product requirements and features and move more quickly to a purchase decision. They are the gatekeepers for Sellers to reach Buyers—whether buying optical telecommunications switching equipment or cleaning fluids for contract office cleaners. Influencers are the indirect channels that influence the mainstream purchasers. Sellers must, therefore, establish strong relationships with the many Influencers who have heavy influence over their Buyers.

There are many know Influencers in the purchasing process, including:

Web Content Publishers

Vertical Web Sites/Portals

Comparison Sites

Search Engines

Discussion Groups

FAQs

Links Pages

Print Publications

Buyer's Guides

Directories

Analysts

Industry Analysts

Financial Analysts

Industry Associations/Forums/Regulatory Bodies

Industry Standards/Trends

Membership Directories

Members Listed by Product/Services Categorizations

Industry Statistics

Other Media

Radio/Web Broadcast

TV/Web Broadcast

### SUMMARY OF THE INVENTION

At its core, the present invention is a massive database of product/service data, company and personnel information, contact information, personal preference information, event information, messages and communications, news, images and just about every other conceivable type of digital marketing collateral. The system of the present invention will alternatively be referred to as “mBlast”.

The Gateway is a rich supporting layer of web-based applications for inputting, accessing, comparing, sharing, challenging, hosting and researching this data. The invention also offers a variety of supporting applications for the exchange of data such as APIs, pre-coded modules and hosted environments.

The methodology for the technical design of is to keep the data layer independent of the application layer as much as possible, meaning that the supporting applications are not a dependency for the data design and vice-versa. The data layer is architected for maximum flexibility in usage by a wide variety of applications, both now and in future releases and additions to the Gateway. The data layer is designed to allow for an infinite variety of data types, as more and more varied product/service categories are included and as the product matures in scope.

A key to the power of present invention is that every unit of data accumulated will allow a wide variety of information to be attached to it. A supporting data layer will contain meta and supporting data about each product/service/company data field, and will allow for expansion of the supporting data as the scope of the application grows.

The architecture of the invention uses a familiar n-tier web-application model. The back-end network consists of data warehouses, messaging servers, transaction servers, application servers, data exchange layers, and other supporting components connected to the internet. The middle-tier application layer consists of compiled application objects that communicate with the back end layer and the user interface. The user interface consists of, for the most part, web pages hosted on a public web server and dynamically generated from script-based templates. This architecture allows for maximum flexibility and scalability. Any piece, or entire layer, can be replaced or modified at any time without compromising existing functionality. We have chosen a Microsoft-based platform for the initial release of the Gateway. This platform is robust, and offers a variety of tools that can rapidly increase the time to market for web-based applications. However the architecture is not dependent on the Microsoft platform, which allows the opportunity to migrate some or all of the application to another platform at any time.

Features

Gateway Environments

The Gateway is the web-based user interface portion of mBLAST. The Gateway is accessible via the World Wide Web, though registration is required for access by end-users. The Gateway consists of three main areas; data input, data output and data management. The Gateway provides a comprehensive collection of applications for performing these functions. The data management capabilities are provided in part a customizable end-user environment for leveraging the features of the invention.

Data Access—The Access Modules of the program allow for output clients to receive the data from the gateway. In the On Demand mode, users enter the system via a USERID/PASSWORD entry. They can view many different listings of the data, depending on their particular interest. Since the data is hierarchical (industry, product group, company, product line) users can click down to as discrete a listing as they require. Information is viewable in a listing format. There is also a matrix view format that allows users to either Select All or Select Specific Sellers to create a custom matrix; users have the option of selecting all possible fields for that category or selected fields as well. There is a transpose option that allows views with either features or Sellers across the top horizontal headers, with the Sellers or features in the vertical headers. Users can save data viewed as a file and send it as an email attachment. Data output modules include Buyer's Guide Matrix, Side-by-Side Comparison Engine, Company Profiles, Link Pages, Data Mining Engine, Glossary, etc.

Data Input—In this module, corporations can enter their data into predefined fields. Users enter the system via a USERID and PASSWORD-protected entry. Emphasis of the interface is on click boxes and radio buttons, with as little open text entry as possible to maximize the apples-to-apples comparison of the data. Each company/division has its own profile in the database core against which all data is attached. Corporations can select what industries and product categories in which they participate, and for each product category they are presented with additional screens for data entry, with most products having about 25 fields on average representing that product category.

My mBLAST—homepage for registered mBLAST users. Provides easy access to mBLAST features and personalized services, including messaging, “delta” data change notifications, automated data collection engine, etc.

mBLAST Gateway Supporting Applications

In addition to the central functions of inputting and extracting data, mBLAST Gateway offers supporting applications that leverage the data and invites the Seller and Advisor communities to interact with mBLAST.

Automated Supplemental Data Collection Engine

Several other tools will be offered to the input and output side clients that help create a set of capabilities that builds repeat visits and loyalty to the gateway itself. One of these is the Supplemental Data Collection Engine, which is an automated robot/spider that is constantly searching the Web for information pertinent to different tools on the site. For instance, PR personnel are likely to be interested in how their latest press release was covered by various publications, newsgroups, Web sites, etc. Specific press releases could be tied to a data collection spider that would visit regular sources of content for their coverage of the topic, driven by key words from the release. This engine could be used to drive competitive tracking capability for companies, or competitive article tracking tools for reporters who want to see how others covered their same story. This tool will be accessible throughout the gateway in different ways.

Messaging Engine

The Messaging Engine is a powerful, email-based tool present throughout the gateway's screens. On different screens it provides different support. For instance, the Data Access On Demand Module/Matrix Mode, enables the user to send a copy of the matrix shown to all public relations managers for each of the companies listed—so a reporter getting ready to run a story based on those facts can shoot the matrix off to the pertinent PR personnel for a final review before publication. The Data Access On Demand Module/Listing Mode, enables the user to send an email to all the PR personnel for the companies listed/checked, replacing many individual calls or emails to accomplish the same thing. Indeed, as the PR personnel register their names and areas of responsibility on the input side of the gateway, they enable a communications path to be created on the output side that makes the overall communications process far more efficient and direct. Future plans include enhancements to include functionality associated with instant messaging and unified messaging.

Data Validation Module

A sophisticated data validation module enables clients to double check data, to make use of the email engine to send data around the client's firm, and to perform side-by-side comparisons of products against the competition. In essence, this is a valuable competitive analysis and product management engine for marketing departments and product managers. Companies can enter proposed products online in a draft mode to see how they would stack up with current competitive products. Information is presented in an easy-to-understand matrix format. Companies can also enter data in advance and embargo the data so that it is only available to the public at a specific point in the future—such as would be required with a new press released product.

A key part of the data validation module—and where it draws its name—is the comment communications chain capability, which is visually demonstrated by the “Challenge” button. The Challenge button is an icon in the upper, right-hand corner of the screen that allows the present corporate marketing user to contest information presented by a competitor. So, if Company A believes that a cell of information from Company B in the presented matrix is not quite true, they can click on the Challenge icon and then click on the cell in question, and an interactive comment field is created. Company A would enter the rationale for questioning the data (the questioner, as initially planned, would be anonymous to Company B but not to mBLAST) and hit submit. An email is sent to 1) the designated PR contact for that product at Company B, and 2) mBLAST's staff, for monitoring. The Challenge icon remains in the corner of the cell in question until a response from Company B is received by the gateway. Upon receipt of a response (notification of which is sent to 1) the questioner at Company A and 2) mBLAST's staff for monitoring), the icon reverts to a Comments Available icon which permanently remains associated with that cell.

This feature is critical to the success of the mBLAST business model as it provides a mechanism for those who know most about those products—the Sellers themselves—to keep each other in check. Since this data is sent out to many different output clients, it becomes a critical part of corporate positioning to maintain watch over competitor data as well as one's own. It also relieves mBLAST of the burden of having to play middleman. Note that mBLAST is involved in the early stages of this process in a monitoring capacity; this is to watch for abuse and misuse of the feature. mBLAST may have to limit the number of times that this feature may be invoked to prevent some companies from questioning every single cell of every single competitor. (There is more discussion of this feature under Data Collection and Management heading later in this document.)

Importantly, these comment streams also provide Advisors with great angles for potential stories. In this sense, corporate positioning can be applied on top of mere data in this data stream.

mBLAST Support Applications and Value-Added Services

mBLAST also offers a variety of support applications and value-added services to clients and end-users, including:

Data Entry-Automated Push/Pull Module—If a firm already has product and corporate information databases, mBLAST 's gateway has open APIs that allow direct interface to the site for continual updating. mBLAST will accept any data that conforms to its data structure—using a record layout format publicly available on the gateway. mBLAST will accept data files in both tab delimited formats or XML coded formats. Direct, real-time feeds are also possible for select applications where it makes sense, such as with service availability (i.e., where service is presently available; this data tends to be highly proprietary, but makes sense to funnel through a gateway for ease of use). In this sense, the gateway might be “pulling” data from the client sites as opposed to them pushing data to the gateway.

Data Access-Automated Push/Pull Module—The direct push/pull module is more tuned towards self-feeding APIs. An output client might regularly download a new file to incorporate on its site or might choose to receive alerts from the gateway with “delta” records of changed data. Data is sent out in a specific format, and output clients are expected to create/adjust their programming to take advantage of these feeds. For the largest shopping portals such as AltaVista and Yahoo!, mBLAST will conform to their APIs for automated distribution of product information to these sites on behalf of its selling organizations.

Hosting—mBLAST will offer ASP-like hosting services, which will allow Web sites to include Buyer's Guides and other mBLAST modules in their Web sites without incurring the expense of site programming fees. mBLAST will work with customers to adopt the look and feel of their sites on its servers, providing a seamless experience for customers. mBLAST intends to resell the hosting services of its partners in providing these services.

Application Objects

The middle tier of the mBLAST architecture is a layer of application objects that comprise the business logic and perform the bulk of the Gateway functions. These objects are written in Visual Basic because of the quick implementation time allowed by the language. VB, in combination with a multi-system MTS environment allows excellent application scalability. For processor intensive objects or objects that may cause bottlenecks within the application, those will be developed in C++ or Java. Ideally the entire middle tier application object layer will be developed in C++ or Java a to allow for cross-platform scalability and to take advantage of the robust both-threaded architecture. The modular design of mBLAST will allow us to port the application objects to C++ or Java one piece at a time as is necessary.

The application objects will expose properties, methods and functions to allow control by the front-end scripting templates and by back end components such as databases, messaging servers, etc.

Data Access Objects—User Interface

Matrix Generator—accept user input to generate custom matrices of mBLAST data—ability to save Matrix designs in user account

Comparison Engine—The Comparison Engine module enables you to compare any range of companies and features against one another—creating a more customized experience for viewers

Company Profiles—can be created/modified by form generator and linked to presentation templates

Link Pages—can be created/modified by form generator and linked to presentation templates

Data Mining Engine—sophisticated search capabilities across mBLAST data sets

Glossary—can be user defined or linked to from other sites

Data Packaging Module—Generate downloadable/email attachment file from screen data

Data Validation Module—allows a variety of supporting data to be attached to each data unit such as challenges and comments.

Data Spider Module—configurable search agent that spiders internet sources for pertinent data

Data Query Module—Coordinates database queries (searches, data retrieval, add/delete/update records)

Data Input Objects—User Interface

Form Generator—creates web-based forms based on pre-specified criteria (using the Administrator Form Creator)

Data Query Module—Coordinates database queries (searches, data retrieval, add/delete/update records)

Messaging Object

Features:

web-based email environment

instant messaging

unified messaging

file attachment capabilities

Fax/pager capabilities

smtp outgoing

pop3 incoming

Automated Data Input Modules

Automated Input Push Module—API connections to mBLAST data core for automated push delivery of data by input clients

Automated Input Pull Module—API connections allowing mBLAST automated retrieval of data from input client databases

Data Spider Module—configurable search agent that spiders internet sources for pertinent data

Automates Data Access Modules

Automated Access Push Module—API connections to output client databases allowing automated push delivery of mBLAST content

Automated Access Pull Module—API connections to mBLAST data core for automated retrieval of data by output clients

Hosting

The hosting service will leverage the User Interface Data Access Objects utilized by the mBLAST Gateway. An additional object layer will coordinate the administrative aspects of the hosting solution.

Hosting Administrative Objects:

Hosting configuration module—could be coded into templates

Branding module—coordinates the branding of the hosted solution to conform to the client site graphics/navigation etc.

Pre-Coded Implementation Modules

The pre-coded solutions will be script-based web-page templates that make remote calls to the mBLAST network for data and functionality. These modules can be created by packaging the mBLAST user interface templates into a generic format.

Pre-coded modules include:

Buyer's Guide

Events Listing

Link Pages

Glossary Listing

Any HTML Presentation of data within the mBLAST system

Administrative—New Product/Service Definition Module

Need better understanding of the process to create a new product/service vertical before this module can be fully defined

New Product/Service Creator

Product/Service Hierarchy creator

Data Field Creator

Input Form Creator

Administrative—Content Management Module

This module allows for a cookie-cutter type approach to the user interface development. This allows all interface components to be mixed and matched to create generic interface templates, which then dynamically create the web interface based on user-based criteria (i.e. input form templates generate correct category input forms based on the category selected by the user).

There are a wide variety of off-the-shelf Content Management Solutions that could provide the needed functionality.

Web Templates

The user interface of the mBLAST Gateway is created with script-based web templates. This modular, template-based design allows for dynamic generation of web output based on the data set and the supporting application objects. This design offers several benefits;

Minimizes development time—Allows for reuse of templates for any product/service category without creating new code.

Keeps business logic out of web layer—logic encapsulated in the application object layer and Data Layer for better scalability and security.

Modular approach allows interface components to be changed/add/removed independently of other components without rewriting existing code.

Script-based front-end interfacing with application objects can leverage lower cost, and more plentiful developers for interface development than if the entire application was developed at the web layer (i.e. using scripting for all business and function logic).

mBLAST Gateway Template Areas

Following are the different sections that comprise the mBLAST Gateway environment;

mBLAST introduction—marketing environment for the mBLAST offering. This section will include:

Descriptive content

Web-based demonstrations of mBLAST functionality

Messaging

Registration—environment to register for mBLAST as either an output or input client

Log In—authorization component to allow entry to various mBLAST environments. Sets level of authentication for authorized users

Input Forms—data collection environment for Product/Service data

My mBLAST—customizable environment for utilizing the various data access and input components, messaging

Contact Companies—Messaging environment for communicating with specific company PR contacts

Create/Edit Matrix—Data Access components interface—create or edit Buyer's Guide Matrixes, Side-By-Side Comparisons, Company Information, Links, Directories, etc.

Edit Profile/Preferences

Data Validation—sub-section of the Data Access Component interface—allows users to attach supporting data to existing product/service fields, embargo input data, etc.

Messaging—standalone section (i.e. web-based email client) and also a sub-section of Data Access Component interface—allows user to email data, contact companies, etc.

Hosted Environment—configurable environment utilizing some or all of the Data Access components

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is a block diagram of the system of the invention;

FIGS. 2-8 are pictorial representation of various aspects of the present invention; and

FIGS. 9-11 are flow charts illustrates the operation of the present invention.

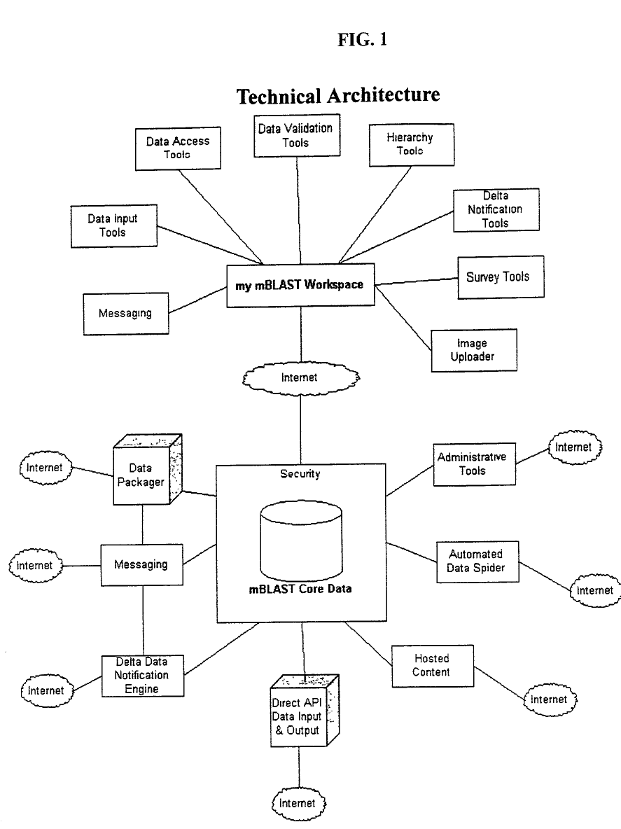

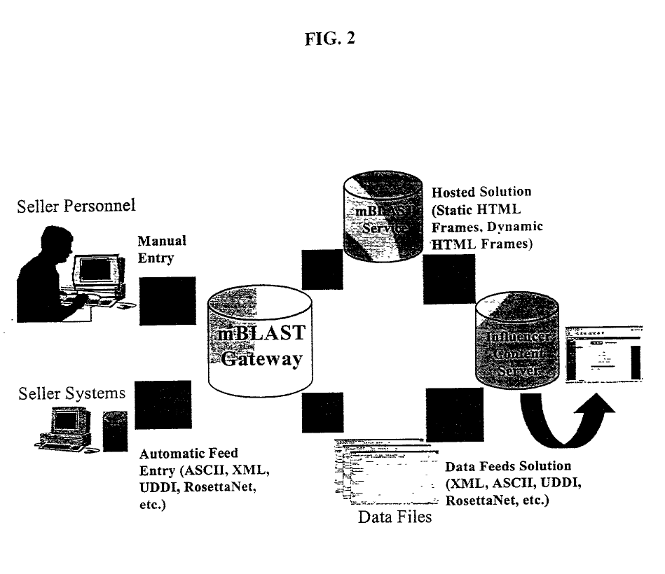

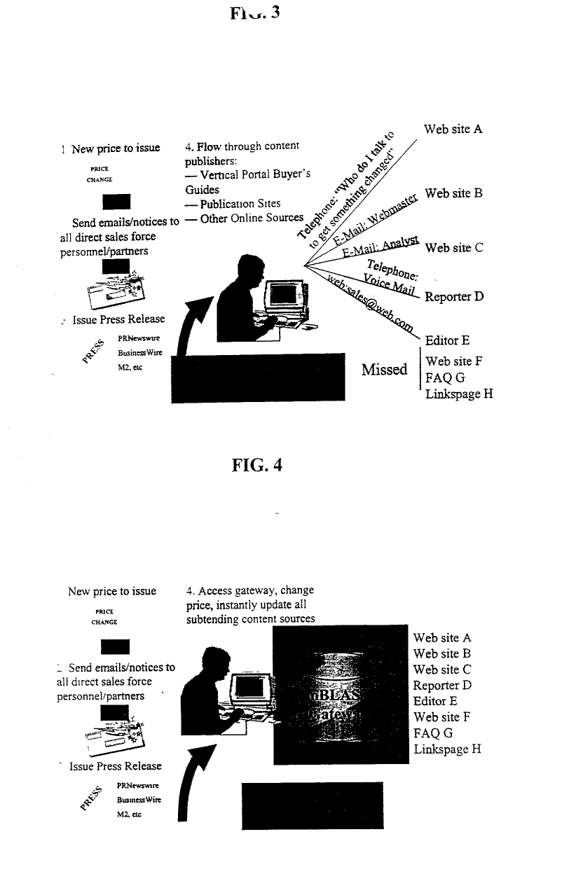

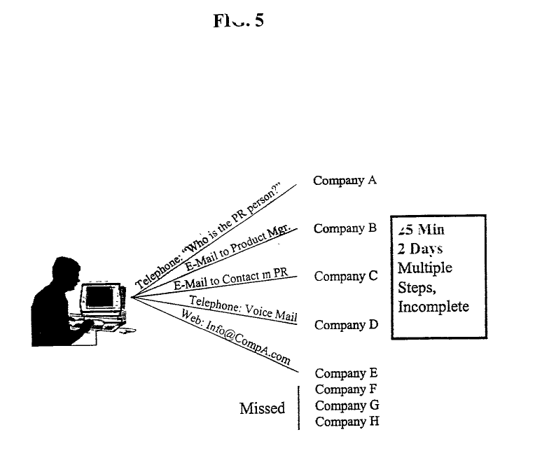

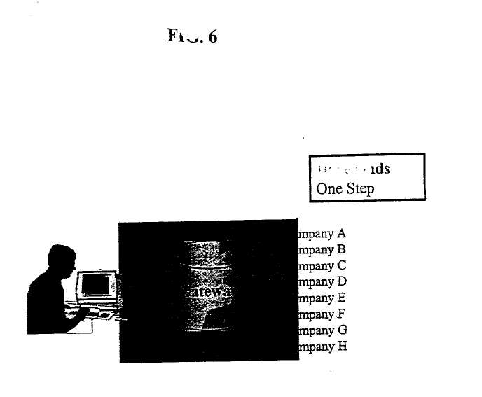

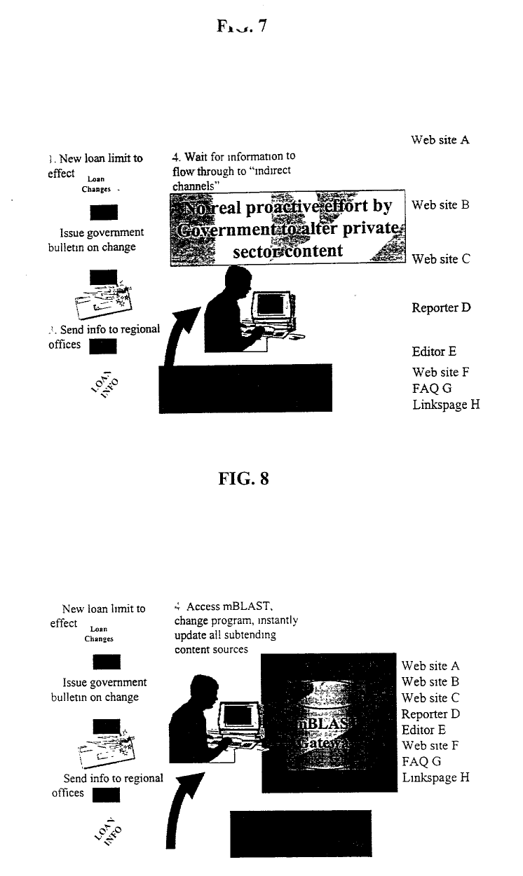

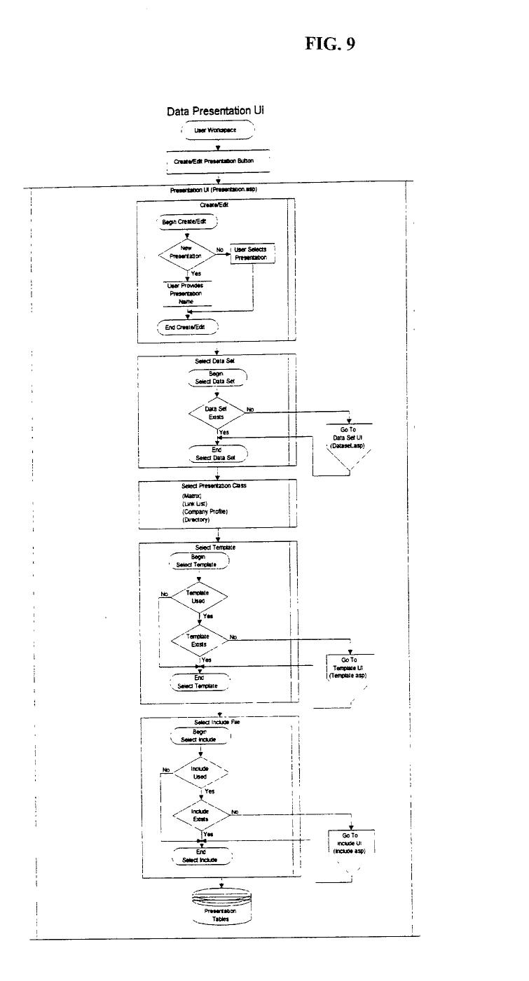

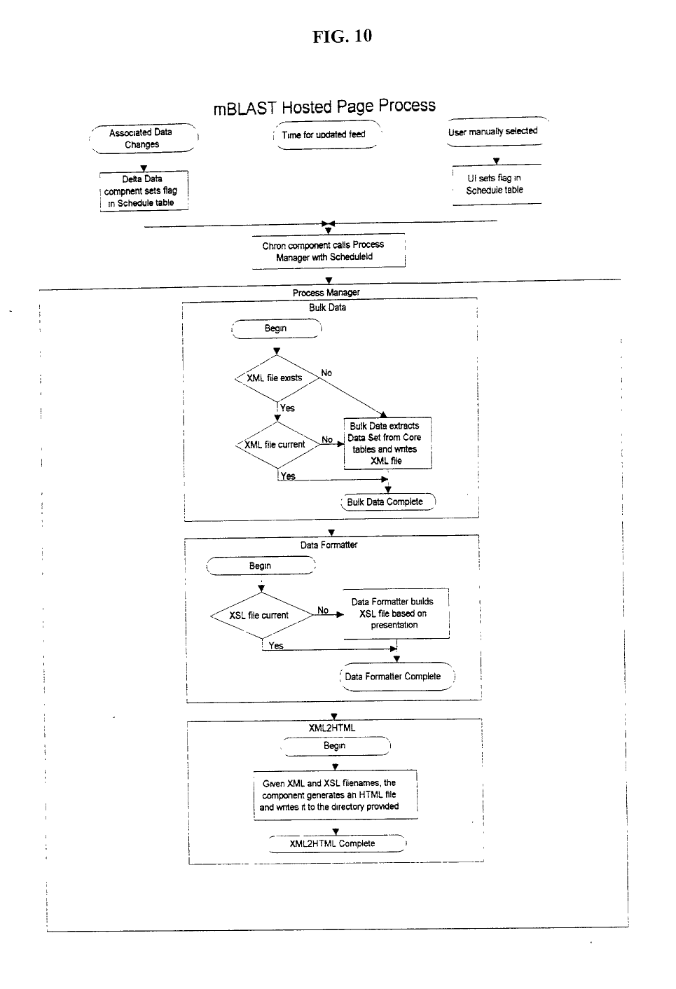

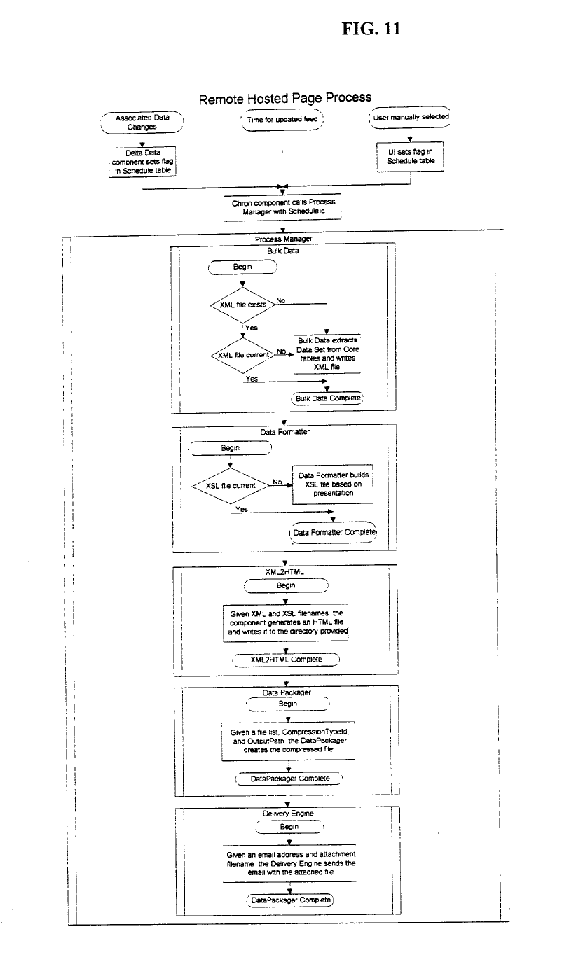

### DESCRIPTION OF THE PREFERRED EMBODIMENT

In accordance with a preferred embodiment of the present invention, the system has a four-tier architecture.

User Interface

The first tier is the User Interface layer. This layer allows the user to input information into the system and displays information for the user to view. The UI layer is a combination of a web browser client and a web server. The web browser client can be any recent browser that supports HTML and Javascript (Internet Explorer or Netscape). The web server is Microsoft Internet Information Server, using Active Server Pages as a script language. The web server composes the HTML that is sent to the browser client, and interacts with the Business Logic tier.

Although the web browser is the primary UI, the system also supports a variety of other methods for getting information into the system and for retrieving information from the system, as illustrated in the diagram above. Information can be delivered via email, instant messaging, and in files in most file formats, such as XML. Information can be delivered instantly when information changes, via alerts, or batched and delivered on a scheduled basis.

Business Logic

The second tier is the Business Logic layer. This layer is responsible for encapsulating access to the database tiers, and for applying business rules, data validation, and business processes to the data when it is written to the database or retrieved from the database. The business logic layer interacts with the UI layer and the data/metadata layers.

The Business Logic layer is a set of COM applications written in Visual Basic.

Metadata

The third tier is the Metadata layer. This layer is a “data dictionary” that provides a definition of the raw data within the system, and stores rules for editing the data, retrieving the data into streams of information, and displaying the data in formatted presentations for the web and reports. The Metadata layer is also responsible for applying security to the data (restricting who can access and edit each unit of data). The Metadata layer interacts with the Business Logic and Data layers

The Metadata layer is stored in database tables in a Microsoft SQL Server database. Data

The fourth tier is the Data layer. This is where the raw data is stored. Because the system defines the raw data using metadata, the raw data can be stored in a set of common tables. So different kinds of records, each with a variable number of fields and a variable number of values for each field, are all stored in the same tables. New records, forms, and datasets can be defined without making changes to the structure of the SQL Server database. This allows the mBLAST system to manage (input, edit, display, report) any kind of data without programming changes. The Data layer interacts with the Metadata layer.

The Data layer is stored in database tables in a Microsoft SQL Server database.

mBLAST System Technical Overview (Software Design Spec)

General Overview

mBLAST uses server-side ASP (Active Server Pages) and VBScript as the scripting language for delivering the HTML-based user interface. Client-side javascript is used minimally and only when necessary, to avoid problems with older browsers. Database access and business logic resides in COM objects that are written in Visual Basic 6. Microsoft SQL Server is as the SQL database, and stored procedures are used extensively to reduce traffic between the web server and the database server.

System Concepts

mBLAST is designed to allow arbitrary sets of data to be entered into the database, edited, and then published into HTML pages or XML documents. The information required to define the form at and logic for inputting and outputting this data is stored in tables and can be edited by end users. The mBLAST system uses its own jargon for referring to the data and the definitions of the data, as follows.

Form: A form is a definition of an input screen. Included in the definition is the title of the form, and the name and type of each input field on the form.

Form Group: A form group is a set of related forms. When the user is entering data into a form, the system allows the user to navigate from one form to the next form within the form group.

Question: A “question” is actually the definition of an input field on the form. There are a number of input types available, including all of the standard html input types like text and textarea, as well as several enhanced types, like type for “customer”, “phone number”, or “date”. Each type has a number of attributes that define how the question will appear on the page, and may include attributes that are specific to the question type. For example, the textarea type allows “rows” and “cols” to be defined, while the phone number type has an attribute that determine whether or not an extension is allowed.

Form Editor: The form editor is the user interface for defining forms, form groups, and questions. It's also known as “Edit Form Groups” within the mBLAST menu.

Form Generator: The form generator creates HTML files for each of the forms in a specified form group. The HTML files consist of a wrapper file (which contains include files for the template that the form is displayed within, and also includes the form itself), a form include file (which contains subroutine calls to the form engine for each of the questions on the form), a help file for the form, and two files that allow the data in the form to be displayed. The wrapper file allows the form to be added or edited, while the display files allow the form to be view.

Form Engine: The form engine is a set of subroutines in an include file (FormIncludes.asp) that display the various input types for the form, and allow the data on the form to be validated and saved.

Session: A session is an instance of data for the form. For example, for a company profile form, there will be a different session for each company that is entered into the form.

Core data: “Core data” refers to the data that is saved for a session. Because a form can allow any kind of data to be entered, the data is stored in generic files. So data from a company profile form is stored in the same generic “core data” files as data for a user profile. Each record in a core data file contains the value of a single question, for a single session. So if a form has twenty questions, there will be twenty records in core data for a session for that form. There are three core data files: core_int, core_varchar, and core_text. Core_int stores numeric data; core_varchar stores textual data up to 255 characters, and core_text stores textual data of more than 255 characters. Note that because each question is stored in a separate record, it is complicated to retrieve all of the questions for a form in a normal recordset format, where each record would correspond to a session, and each question to a field in the record. mBLAST uses stored procedures to convert core data into recordset formats.

Dataset: A dataset defines a set or group of sessions.

Presentation: A presentation is a definition of an output screen or screens. Included in the definition is pages that will be displayed; the sections within each the HTML for the page top, for between sections, and for the page bottom; indexes; and the data to put into the rows and columns in each section. Style sheets can be defined and elements of the style sheet can be applied to the elements of the page.

mBLAST's core data can be thought of as a database (a database with the SQL server database). A form or form group is a like a table. A question is like a field in the table. A session is like a record in the table. A dataset is like a view. This allows mBLAST to define new tables without needing to create new tables in the database, and also to create the HTML for entering, editing, and displaying the data from the tables.

Alert: When certain events on the system occur, an alert is raised. For example, whenever a form is saved, an alert is raised. The system allows actions to be defined for the alert. For example, someone can be notified, via email or IM, based on the message defined by the alert.

User Interface Concepts

After logging in the user, the system displays a “workspace UI”. The UI is divided into several areas: the title bar, the workspace menu, the navigation bar, and the content area.

The title bar is simply a graphic that displays at the top of the screen.

The workspace menu is a set of buttons on the left side of the screen. Each button points to a module, or functional area, within the system. The set of buttons varies depending on the type of user. For example, a Marketing user sees a different set of buttons than a Publisher sees. In addition, the buttons may be grayed out if the user does not have sufficient rights to access the module.

The navigation bar displays under the title bar along the top of the screen. Included in the title bar is a drop-down sub-menu, which allows the user to navigate within a module. This sub-menu is populated based on an array that is set in each in ASP page. Other navigational elements may also appear within the navigation bar, including a link to context-sensitive help, and an Alias sub-menu, if the user has permission to access more than one company. Note that the navigation bar is used for providing access to the previous page or pages, rather than buttons, icons, or links on the form itself.

The content area is a white box in the middle of the screen where the main content for a page is displayed.

Within the content area, there are normally several elements: a module title, a page title, a page description, and a list or an input form. Each of the elements uses classes from the main style sheet to ensure that the look and feel is consistent from page to page. (Note: the style sheet classes were added only a few months back, so older modules in the system may not yet have been modified to use them).

The module title should correspond to the name of the module and remains the same on every page within the module.

The page title appears underneath the module title, on every page except for the module's main page (which doesn't need a page title). The page title is preceded by an mBLAST Logo bullet.

The page description is a short set of instructions for the user, which appears under the page title, and is optional. This area is also used to display error messages. Error messages always use a red font.

The list is an HTML table containing a list of records and action icons. The general format of the list is a title (describing the contents of the list); a “new” row for adding a new record, if applicable, one or more “edit” rows for viewing, editing, and deleting records; and a legend that describes each of the icons. Columns within the list generally include an ID column identifying the specific record, one or more columns containing information from the record (names, descriptions, etc.), and an actions column containing icons. The action icons allow the user to perform functions for the selected row, like add/edit/delete/view.

The input form is an HTML table containing an input form. The general format of an input table is a title (describing the contents of the form); a set of rows for each field in the form, containing a prompt on the left, and an input field on the right; and a Submit button at the bottom.

So a list is used to display a set of records with action icons, while an input form is used when adding, editing, or deleting a single record.

In many cases, the information that is being entered is more complicated than a single set of records. For example, in the form editor, the first page displays a list of the form group records, with add/edit/delete capabilities. But for each form group, there can be multiple forms, and for each form, there can be multiple questions. The UI handles this by adding a “View” icon for the set of child records. So in the form group list, there is an icon to “view forms” for the form group. Clicking that icon takes the user to another page that displays the form group that was selected, and that shows a list of the forms for the form group, with action icons for each form. On of the action icons for the form is to “view questions” for the form. This takes the user to another page, that lists the form group and form that was selected, and that shows a list of the questions for the form. And so on. So there is a hierarchical relationship between the parent and children forms. As the user navigates deeper into the hierarchy, each of the previous pages is added to the navigation bar's drop down list so that the user can navigate back to any of the previous pages.

Security

Each user has a user ID and password, which is validated against the Users table. The user can belong to one or more companies based on the User_Join_Company table. The User_Join_Company table contains a “Default” bit field for the company that the user is currently associated with.

When the user logs in, he is issued a SessionGUID, which is stored into a cookie. Each page on the site checks for this SessionGUID to determine who is logged in, and then checks to see whether the user has permissions to access the page. Permissions are granted based on whether the user belongs to a group that has access to the object that the user is trying to access. If the user does not have permission to access a page, he is redirected to an “access denied” page.

The SessionGUID also has an inactivity timeout associated with it. When the session times out, the user is redirected to the login page.

There are two tables in the system for handling object permissions: Objects and Object_Permissions. The Objects table defines each of the security objects. There are several types of objects. Type 5 is for menu items (or modules), while other types grant access to forms, hierarchies, questions, etc. The Object_Permissions define which groups have access to which objects.

Code Structure

Each ASP page in mBLAST is structured somewhat similarly, using a wrapper file and two code files. The wrapper file is stored in the /workspace directory (or a subdirectory of that directory), while the code files are stored in the /code/workspace directory (or a subdirectory of that directory).

An example of a wrapper file:

<%@ Language=VBScript %>
<%
strObjectId = 39
strObjectType = 5
strTitle = “mBLAST − mBLAST Internal”
CheckSecurity
%>
<!--#include virtual=“/code/workspace/alert/company/alertlistupdate.asp”-->
<%
DisplayTemplateTop strTitle, True, True
%>
<!--#include virtual=“/code/workspace/alert/company/alertlist.asp”-->
<%
DisplayTemplateBottom
%>
<!--#include virtual=“/template/template.asp”-->

Note that Option Explicit is not used. While this would be preferable for performance reasons, it was not required when the system was originally designed and there has not been time to edit all of the pages to support it.

The strObjectId is the object used for permissions checking, and the strObjectType id the type of object (where 5 is a menu item or module). The value of strObjectId comes from the PageId field in the WorkspacePages table.

strTitle sets the HTML page title, and should be the same for every page in the module.

CheckSecurity checks to see if the user is logged in, if the SessionGUID is current, and if the user has permissions to access the page. If not, the user is redirected appropriately.

The first include file is an “update” page, which contains code that must be executed before any of the page's HTML has been written. This is used to handle form submissions (when editing a record for example), to retrieve recordsets and other data, and to set up the navigation submenu. Note that forms almost always submit to themselves rather than to another form. By convention this page is that same as the name of the wrapper page and code page, but with “update” appended.

DisplayTemplateTop writes the HTML at the top of the page, including the navigation bar and the menu . . . everything up to the content area of the page.

The second include file writes the HTML within the content area.

DisplayTemplateBottom writes the HTML at the bottom of the page, everything after the content area of the page.

The last include file is for the template subroutines, including CheckSecurity, DisplayTemplateTop, and DisplayTemplateBottom.

The wrapper file is used so that the page can be branded with a different look and feel. To do this, the wrapper file is copied to the branded directory, and the template include is changed to point to the branded template subroutines. This allows a single set of code pages to be used.

An example of an update file:

<%
Dim objAlert, objAlertRS
′Get alerts
Set objAlert = Server.CreateObject(“mBAlert.CAlert”)
objAlert.Active = 1
Set objAlertRS = objAlert.FetchAlertsByActive
Set objAlert = Nothing
′Set up jump array
Dim aryJump(1,0)
aryJump(0,0) = “/workspace/security/company/security.asp”
aryJump(1,0) = “Security Administration”
%>

Note that even though Option Explicit is not used, we still attempt to Dim all variables. This example shows a recordset being obtained by calling a method in a component. Then the “jump” array is set up. This array is used to define the drop-down list or sub-menu in the navigation bar.

A simplified example of a code file:

```
<%
Response.Write “<table border=0 cellpadding=1 valign=top>”
Response.Write “<tr><td><a class=sectionHeader>Security Administration</a></td></tr>”
Response.Write “<tr><td><a class=subheadermaroon><img
src=/images/bullet.jpg>&nbsp;Edit Alerts</a></td></tr>”
Response.Write “<tr><td>Use this page to view the alerts that are available, and to add
recipients for the alerts.</td></tr>”
Response.Write “<tr><td><font color=red>” & strError & “&nbsp;</font></b></td></tr>”
Response.Write “</table>”
Response.Write “<table class=contenttable cellpadding=3 cellspacing=1 border=0>”
Response.Write “<tr class=contenttitle><td colspan=3 class=contenttitle>Alerts</td></tr>”
Response.Write “<tr class=contentheader>”
Response.Write “<td class=contentheader>Id</td>”
Response.Write “<td class=contentheader>Description</td>”
Response.Write “<td class=contentheader>Actions</td>”
Response.Write “</tr>”
If Not (objAlertRS Is Nothing) Then
  Do Until objAlertRS.EOF
  Response.Write “<tr class=contentedit>”
  Response.Write “<td class=contentedit>” & objAlertRS.Fields(“AlertId”) & “</td>”
  Response.Write “<td class=contentedit>” & objAlertRS.Fields(“Description”) & “</td>”
  Response.Write “<td class=contentedit><a href=recipientlist.asp?AlertId=” &
objAlertRS.Fields(“AlertId”) & “&PrimaryMessageId=” & objAlertRS.Fields(“MessageId”)
& “><img border=0 height=16 width=16 src=/images/hier_pers.gif alt”“Edit
recipients”“></a>”
  Response.Write “</td>”
  Response.Write “</tr>”
  objAlertRS.MoveNext
  Loop
  Set objAlertRS = Nothing
End If
Response.Write “<tr><td colspan=3>”
Dim aryLegend(0,1)
aryLegend(0,0) = “edit recipients”
aryLegend(0,1) = “hier_pers”
DisplayLegend aryLegend, 2
Response.Write “</td></tr>”
ResponseWrite “</table>”
%>
```

This illustrates the use of classes to define the various elements of the page (module title, page title, page description, list form including title, edit row, and legend.)

Also, note that Response.Write is used to output all of the HTML, rather than context switching between VB code and HTML. Eliminating the context switching allows the code to execute slightly faster in the current versions of ASP.

Components

Perhaps the most important component is mBData. This component is used to access the SQL database. It should be used for any database access, both from within a component and from within an ASP script. (Most of the time, you should not need to access mBData directly from ASP, since there should be another component that you can use).

mBData allows both SQL calls and stored procedure calls. However, use of SQL calls is deprecated and will cause your code to be rejected during our review process. To access the database, you will first need to write a stored procedure, then access that stored procedure via mBData. mBData supplies two methods for stored procedures: ExecuteSP and ReturnSPResults. The first simply executes the procedure, while the second returns a record set from the stored procedure. Neither method supports the use of output parameters, so the stored procedure should be written to return a result set.

Here's an example of a call to mBData, from within a component:

```
Set objData = CreateObject(“mBData.CData”)
Set objRS = objData.ReturnSPResults(“InsertCompany”, _{—}
  adVarChar, 255, pstrCoName, _{—}
  adInteger, 4, pintPricingLevelId, _{—}
  adInteger, 4, pintCoType)
Set objData = Nothing
```

Note that you specify the stored procedure's parameters by using the parameter type (adVarChar), the length of the data (255), and the data (pstrCoName).

The following briefly describes the purpose of mBLAST components. Components that are obsolete or are not actively being used are not listed. We can provide source code for individual components as needed for your project.

mBAlert.dll—Methods for adding, editing, deleting, and fetching alerts, and for raising alerts.

mBAreaInterest.dll—Methods for adding, editing, deleting, and fetching “Areas Of Interest” and scheduling alerts for areas of interest (where the user specifies his interests using system hierarchies).

mBAuthor.dll—Methods for adding, editing, deleting, and fetching form groups and related tables like Questions.

mBBulkData.dll—Methods for importing and exporting data in XML format.

mBBulkFeed.dll—Methods for adding, editing, deleting, and fetching bulk feeds (schedules of data feeds to remote systems).

Introduction

This document is indended to serve as the working Application Design Specification for the mBLAST project, and will include both high and low level design specifications.

mBLAST Overview

At its core, mBLAST is a massive database of product/service data, company and personnel information, contact information, personal preference information, event information, messages and communications, news, images and just about every other conceivable type of digital marketing collateral.

The mBLAST Gateway is a rich supporting layer of web-based applications for inputting, accessing, comparing, sharing, challenging, hosting and researching this data. mBLAST also offers a variety of supporting applications for the exchange of data such as bulk data transfer, email notifications, and hosted environments.

A key to the power of mBLAST is that every unit of data accumulated will allow a wide variety of information to be attached to it. A supporting data layer will contain meta and supporting data about each product/service/company data field, and will allow for expansion of the supporting data as the scope of the application grows.

System Overview

The architecture of mBLAST uses a familiar n-tier web-application paradigm; The back-end network may consist of data warehouses, messaging servers, transaction servers, application servers and other supporting components connected to the internet. The middle-tier application layer will consist of component applications that communicate with the back end layer and the user interface. The user interface will consist of, for the most part, web pages hosted on a public web server and dynamically generated from script-based templates. This architecture allows for maximum flexibility and scalability. Any piece, or entire layer, can be replaced or modified at any time without compromising existing functionality.

We have chosen a Microsoft-based platform for the initial release of mBLAST Gateway. This platform is robust, and offers a variety of tools that can rapidly increase the time to market for web-based applications. However the mBLAST architecture is not dependent on the Microsoft platform, which allows the opportunity to migrate some or all of the application to another platform at any time.

Design Considerations

The following are issues that need to be considered when determining a design and implementation approach for the mBLAST application.

Related software or hardware

The application should be designed for cross-platform portability. This does not mean that all application components must be cross-platform capable from day one, but the application architecture must be such that each tier can be ported to another platform without affecting the performance of any other tier.

End-user characteristics

The application should be designed with maximum flexibility in mind, both in terms of functionality and presentation, as the scope of the application will continually evolve and change, and the design will need to support these changes easily and without requiring redesign efforts.

General Constraints

The following are constraints that have a significant impact on the design:

Database Size—Because we anticipate a very high volume of data, potentiall terabytes of data, the Data Layer will need to be designed accordingly.

Database Performance—Because we anticipate a high volume of users, and also plan on implementing automated processes that will further increase the dB Server usage, the Data Layer will need to be designed accordingly.

Goals and Guidelines

Following are priorities that dominate the design of the system's software:

Maximum Flexibility in UI modifications

Ability to easily accept new data categories and types

Bring Core functionality to market first, which allow for the collection of data, then focus on output capability

Architectural Strategies

Summary

The project should be designed using an N-tier approach. Specifically, the program should separate the User Interface, Business Logic, and Database Access. Any of the tiers should be able to be modified without any adverse effects, as long as the interface between the tiers is not changed.

The UI will be HTML output to be displayed by browsers. The UI is any type of server side scripting language. The Business Logic consists of components either running on the web server or a separate transaction server and will be responsible for calling the Database Access components, manipulating the data according to predefined business rules, and passing this information to the UI. The Database Access will be components running on the web server or a separate transaction server and will be responsible for any interaction with the database.

UI Tier

For this project, the UI will consist of Active Server Pages. For scalability reasons, the ASP should not be dependent on any session variables. This will enable the application to be run on a web farm where it is unlikely that the same server will be used for all requests. Using WLBS (Windows Load Balancing Software), it's possible to cluster up to 32 servers in a single web farm for scalability and/or redundancy.

For security reasons, no sensitive information such as usernames and passwords should be contained in the ASP. Instead, this information should be stored in another location such as the registry or UDL files.

Custom Written Components

All custom written components should first undergo a buy vs. build analysis. If it is determined that custom components need to be written, they should adhere to the following guidelines:

All components should be named MBComponentName to make them easily identifiable.

All components should be written to run on MTS (Microsoft Transaction Server).

All components should be written in VB (Visual Basic) unless otherwise specified.

All components should have an API documenting its exposed Properties, Methods, Events and dependencies on other components.

All components should write all unrecoverable errors to an error log.

At a minimum, all components should consist of the following properties:

MsgLogPath—The complete path to the log file to be used for writing unrecoverable errors.

IniPath—The complete path to the INI file used.

NodeName—The name of the computer where the component is running.

Business Logic Tier

The components that make up the business logic should not have any direct interaction with the database. All information residing in a database should be accessed using the Data Access Tier.

Data Access Tier

The Data Access Tier should be written using ADO for database access. Whenever possible, stored procedures should be used instead of embedded SQL. This provide better performance and should make the transition from SQL Server to Oracle or another highly scalable RDBMS easier.

System Architecture

This section describes the main areas of application functionality.

mBLAST Gateway Environments

The mBLAST Gateway is the web-based user interface portion of mBLAST. The Gateway is accessible via the World Wide Web, though registration is required for access by end-users. The Gateway consists of three main areas; data input, data output and data management. The Gateway provides a comprehensive collection of applications for performing these functions. The data management capabilities are provided in part by “My mBLAST”, a customizable end-user environment for leveraging the features of mBLAST.

Data Access

The Access Modules of the program allow for output clients to receive the data from the gateway. In the On Demand mode, users enter the system via a USERID/PASSWORD entry. They can view many different listings of the data, depending on their particular interest. Since the data is hierarchical (industry, product group, company, product line) users can click down to as discrete a listing as they require. Information is viewable in a listing format. There is also a matrix view format that allows users to either Select All or Select Specific Sellers to create a custom matrix; users have the option of selecting all possible fields for that category or selected fields as well. There is a transpose option that allows views with either features or Sellers across the top horizontal headers, with the Sellers or features in the vertical headers. Users can save data viewed as a file and send it as an email attachment .Data output modules include Buyer's Guide Matrix, Side-by-Side Comparison Engine, Company Profiles, Link Pages, Data Mining Engine, Glossary, etc.

COMPONENTS

Matrix Generator—accept user input to generate custom matrixes of mBLAST data—ability to save Matrix designs in user account

Company Profiles—

Link Pages—

Data Mining Engine—sophisticated search capabilities across mBLAST data sets

Glossary—

Data Packaging—Generate downloadable/email attachment file from screen data

Data Validation—allows a variety of supporting data to be attached to each data unit such as challenges and comments.

Data Spider—configurable search agent that spiders internet sources for pertinent data

Data Object—Coordinates database queries (searches, data retrieval, add/delete/update records)

Messaging Engine

Data Input

In this module, corporations can enter their data into predefined fields. Users enter the system via a USERID and PASSWORD-protected entry. Emphasis of the interface is on click boxes and radio buttons, with as little open text entry as possible to maximize the apples-to-apples comparison of the data. Each company/division has its own profile in the database core against which all data is attached. Corporations can select what industries and product categories in which they participate, and for each product category they are presented with additional screens for data entry, with most products having about 25 fields on average representing that product category.

COMPONENTS

Form Generator—creates web-based forms based on pre-specified criteria (using the Administrator Form Creator)

Data Query Module—Coordinates database queries (searches, data retrieval, add/delete/update records)

mBLAST Workspace

Customizeable environment for registered mBLAST users. Provides easy access to mBLAST features and personalized services, including messaging, “delta” data change notifications, automated data collection engine, etc.

COMPONENTS

Matrix Generator—accept user input to generate custom matrixes of mBLAST data—ability to save Matrix designs in user account

Company Profiles—

Link Pages—

Data Mining Engine—sophisticated search capabilities across mBLAST data sets

Glossary—

Data Packaging—Generate downloadable/email attachment file from screen data

Data Validation—allows a variety of supporting data to be attached to each data unit such as challenges and comments.

Data Spider—configurable search agent that spiders internet sources for pertinent data

Data Object—Coordinates database queries (searches, data retrieval, add/delete/update records)

Messaging Engine

mBLAST Gateway Supporting Applications

In addition to the central functions of inputting and extracting data, mBLAST Gateway offers supporting applications to make working within the mBLAST environment easier and Automated Supplemental Data Collection Engine

Several other tools will be offered to the input and output side clients that help create a set of capabilities that builds repeat visits and loyalty to the gateway itself. One of these is the Supplemental Data Collection Engine, which is an automated robot/spider that is constantly searching the Web for information pertinent to different tools on the site. For instance, PR personnel are likely to be interested in how their latest press release was covered by various publications, newsgroups, Web sites, etc. Specific press releases could be tied to a data collection spider that would visit regular sources of content for their coverage of the topic, driven by key words from the release. This engine could be used to drive competitive tracking capability for companies, or competitive article tracking tools for reporters who want to see how others covered their same story. This tool will be accessible throughout the gateway in different ways.

COMPONENTS

Data Spider Component—configurable search agent that spiders internet sources for pertinent data

Messaging Engine

The Messaging Engine is a powerful, email-based tool present throughout the gateway's screens. On different screens it provides different support. For instance, in the Data Access On Demand Module/Matrix Mode, it enables the user to send a copy of the matrix shown to all public relations managers for each of the companies listed—so a reporter getting ready to run a story based on those facts can shoot the matrix off to the pertinent PR personnel for a final lookover before publication. In the Data Access On Demand Module/Listing Mode, it enables the user to send an email to all the PR personnel for the companies listed/checked, replacing many individual calls or emails to accomplish the same thing. Indeed, as the PR personnel register their names and areas of responsibility on the input side of the gateway, they enable a communications path to be created on the output side that makes the overall communications process far more efficient and direct. Future plans include enhancements to include functionality associated with instant messaging and unified messaging.

COMPONENTS

Messaging Engine

Data Validation Engine

A sophisticated data validation module enables clients to double check data, to make use of the email engine to send data around the client's firm, and to perform side-by-side comparisons of products against the competition. In essence, this is a valuable competitive analysis and product management engine for marketing departments and product managers. Companies can enter proposed products online in a draft mode to see how they would stack up with current competitive products. Information is presented in an easy-to-understand matrix format. Companies can also enter data in advance and embargo the data so that it is only available to the public at a specific point in the future—such as would be required with a new press released product.

A key part of the data validation module—and where it draws its name—is the comment communications chain capability, which is visually demonstrated by the “Challenge” button. The Challenge button is an icon in the upper, right-hand corner of the screen that allows the present corporate marketing user to contest information presented by a competitor. So, if Company A believes that a cell of information from Company B in the presented matrix is not quite true, they can click on the Challenge icon and then click on the cell in question, and an interactive comment field is created. Company A would enter the rationale for questioning the data (the questioner, as initially planned, would be anonymous to Company B but not to mBLAST) and hit submit. An email is sent to 1) the designated PR contact for that product at Company B, and 2) mBLAST 's staff, for monitoring. The Challenge icon remains in the corner of the cell in question until a response from Company B is received by the gateway. Upon receipt of a response (notification of which is sent to 1) the questioner at Company A and 2) mBLAST 's staff for monitoring), the icon reverts to a Comments Available icon which permanently remains associated with that cell.

This feature is critical to the success of the mBLAST business model as it provides a mechanism for those who know most about those products—the Sellers themselves—to keep each other in check. Since this data is sent out to many different output clients, it becomes a critical part of corporate positioning to maintain watch over competitor data as well as one's own. It also relieves mBLAST of the burden of having to play middleman. Note that mBLAST is involved in the early stages of this process in a monitoring capacity; this is to watch for abuse and misuse of the feature. mBLAST may have to limit the number of times that this feature may be invoked to prevent some companies from questioning every single cell of every single competitor. (There is more discussion of this feature under Data Collection and Management heading later in this document.)

Importantly, these comment streams also provide Advisors with great angles for potential stories. In this sense, corporate positioning can be applied on top of mere data in this data stream.

COMPONENTS

Data Validation Module—allows a variety of supporting data to be attached to each data unit such as challenges and comments.

mBLAST Support Applications and Value-Added Services

mBLAST also offers a variety of support applications and value-added services to clients and end-users, including:

Data Entry-Automated Push/Pull Module

If a firm already has product and corporate information databases, mBLAST 's gateway has open APIs that allow direct interface to the site for continual updating. mBLAST will accept any data that conforms to its data structure—using a record layout format publicly available on the gateway. mBLAST will accept data files in both tab delimited formats or XML coded formats. Direct, real-time feeds are also possible for select applications where it makes sense, such as with service availability (i.e., where service is presently available; this data tends to be highly proprietary, but makes sense to funnel through a gateway for ease of use). In this sense, the gateway might be “pulling” data from the client sites as opposed to them pushing data to the gateway.

Data Access-Automated Push/Pull Module

The direct push/pull module is more tuned towards self-feeding APIs. An output client might regularly download a new file to incorporate on its site or might choose to receive alerts from the gateway with “delta” records of changed data. Data is sent out in a specific format, and output clients are expected to create/adjust their programming to take advantage of these feeds. For the largest shopping portals such as AltaVista and Yahoo!, mBLAST will conform to their APIs for automated distribution of product information to these sites on behalf of its selling organizations.

Hosting

mBLAST will offer ASP-like hosting services, which will allow Web sites to include Buyer's Guides and other mBLAST modules in their Web sites without incurring the expense of site programming fees. mBLAST will work with customers to adopt the look and feel of their sites on its servers, providing a seamless experience for customers. mBLAST intends to resell the hosting services of its partners in providing these services.

Subsystem Architecture

This section further describes components listed in System Architecture above.

Product/Industry Creator

The Product/Industry Creator component allows the addition of new product/service/industry types into the Product/Service database. This component also allows the creation of relationships between the new category and any available hierarchies.

Functionality:

1. Admin identifies new product/service/industry

2. Admin selects available hierarchies and identifies the correct position or coding sequence for the new category in each hierarchy

Form Creator

The Form Creator component is a foundational piece of the mBLAST solution. The Form Creator has several functions:

Allow an administrator to create or modify an input form using a web-based interface

Allow the admin to attach the new input form to a specific product category or industry or modify the product category for an existing form.

As the new form is created, add the necessary information to the Fields table, the Fields_Join_Product/Service table, Fields_Join_Form table and the Form table to allow for the dynamic generation of forms and the correct insertion of data from the form into the Core Data tables and the supporting tables.

As a form is created or modified, generate and save the input form as an ASP page and create a reference to the location of the file in the Form Pages table.

Functionality:

1. Administrator initiates a new form

2. Admin identifies the product category for the new form

3. Admin identifies the previous form in the form chain (if any)

4. Admin identifies form questions (i.e. Product Name, Product Color etc) and creates the specific input form type for each question

5. Form creator adds the input form configuration information to the Forms table (i.e. Question, input type, validation type, length, order on page, etc)

6. Form Creator ads form questions to the Fields table as the field names for the new product type and maps them to columns in the Core Data tables (i.e Product Name, Column #1, Core_Data_Varchar)

7. Creates relationships in Form_Join_Fields table between the Form and Fields tables

8. Generate the ASP form page and add the form page location to the Form_Pages table.

Core Data Object

This component makes modifications to the Core Data tables and supporting tables based on information from an input form. This component can retrieve (load) data from the Core Data, insert records into the Core Data, update records in Core Data, and delete records from Core Date. This component is also responsible for updating the supporting Join tables, and other supporting tables such as the History table, Product/Service table, etc. This object will perform most of the data manipulation required by other objects. This Object will communicate with a set of stored procedures and pass the required values to allow the stored procedures to perform the required task.

Matrix Creator/Generator

The Matrix Creator/Generator component allows an end-user to create a table of product/service information. The user will be provided with an administrative screen to select the products and product features to include in the matrix. Once the user has selected the matrix parameters, a matrix/table will be generated using Core Data. The user will have the ability to save this configuration for viewing at a later date.

Functionality:

1. The user initiates a new matrix for a particular product type.

2. A matrix creation screen is created with a matrix identifying all available products and all available product features. The user selects the products and features to include in the matrix

3. A new record is added to the Matrix table identifying the Matrix name, and relationships are created in the Matrix_Join_User table, Matrix_Join_Fields table, and Matrix_Join_Products table.

4. The Matrix is generated using the new relationships stored in the database.

5. If the User decides to save the matrix, the data is maintained, otherwise all new matrix data is deleted from database.

Data Packager

The Data Packager component allows the creation of a downloadable or email-attachable file from any data output. For example, a user creates a Matrix, and wants to publish it on her website. Using the Data Packager, she can create a downloadable copy of the matrix in HTML format with all supporting images included. The Data Packager will generate the file and initiate the download. The Data Packager should be able to create multiple file types such as HTML, Excel spreadsheets, Delimited Text File, Access Database, etc.

Data Qualifier

The Data Qualifier component is a key feature of the mBLAST Gateway. The Qualifier allows an infinite amount of supporting or meta information to be attached to the Core Data. The meta information facilitated by the Qualifier is another data type that will actually reside in the Core Data tables, and relationships between the supporting data and the Core Data will be provided by the Core_Join_Meta table. Another table called Meta will contain the list of Qualifier data types such as challenge, response, positioning statement, etc

An example of this “qualification” ability of the Gateway is allowing users to challenge the claims made by competitors, and allowing the competitor to respond to this challenge. This exchange will be permanently linked to the actual data value in question, and will be a viewable part of the data value history.

Image Uploader

The Image Uploader Component allows input users to upload images of various file types. These images can be for Company logos, employee portraits, or product shots. The Image Uploader will allow the user to browser their hard drive, select a file, upload the file to a temporary directory, verify the file type, rename the file using a standard naming convention, and move the file to the correct image directory. The Uploader will also add the file path and name to the corresponding Product/Service/Company/Employee Core Data record.

Automated Delta Data Notifier

The Delta Data Notifier allows users to be automatically notified in the event that any selected Core Data is modified. A change to the Audit table should trigger a search of all users that have chosen to be modified regarding that data unit. Leveraging the messaging component, the pertinent users will be notified via email, pager, etc. or a notice will be included in their mBLAST Workspace environment. For each flagged data unit, a record will be included in the Delta_Notify table and a relationship to the user will be created with the Delta_Join_User table.

Messaging Component

Data Spider Component

Configurable search agent that spiders Internet sources for pertinent data

Automated Input Push Component

API connections to mBLAST data core for automated push delivery of data by input clients

Automated Input Pull Component

API connections allowing mBLAST automated retrieval of data from input client databases

Automated Access Push Component

API connections to output client databases allowing automated push delivery of mBLAST content

Automated Access Pull Component

API connections to mBLAST data core for automated retrieval of data by output clients

The hosting service will leverage the User Interface Data Access Objects utilized by the mBLAST Gateway. An additional object layer will coordinate the administrative aspects of the hosting solution.

Hosting configuration Component

Branding Component

Coordinates the branding of the hosted solution to conform to the client site graphics/navigation etc.

Form Creator

The Form Creator component is a foundational piece of the mBLAST solution. The Form Creator has several functions:

Allow an administrator to create or modify an input form using a web-based interface

Allow the admin to attach the new input form to a specific product category or industry or modify the product category for an existing form.

As the new form is created, add the necessary information to the Fields table, the Fields_Join_Product/Service table, Fields_Join_Form table and the Form table to allow for the dynamic generation of forms and the correct insertion of data from the form into the Core Data tables and the supporting tables

As a form is created or modified, generate and save the input form as an ASP page and create a reference to the location of the file in the Form Pages table.

Step-by-step:

Administrator initiates a new form

Admin identifies the product category for the new form

Admin identifies the previous form in the form chain (if any)

Admin identifies form questions (i.e. Product Name, Product Color etc) and creates the specific input form type for each question

Form creator adds the input form configuration information to the Forms table (i.e. Question, input type, validation type, length, order on page, etc)

Form Creator ads form questions to the Fields table as the field names for the new product type and maps them to columns in the Core Data tables (i.e Product Name, Column #1, Core_Data_Varchar)

Creates relationships in Form_Join_Fields table between the Form and Fields tables

Generate the ASP form page and add the form page location to the Form_Pages table.

Core Data Object

This component makes modifications to the Core Data tables and supporting tables based on information from an input form. This component can retrieve (load) data from the Core Date, insert records into the Core Data, update records in Core Data, and delete records from Core Date. This component is also responsible for updating the supporting Join tables, and other supporting tables such as the History table, Product/Service table, etc. This object will perform most of the data manipulation required by other objects.

Matrix Creator/Generator

The Matrix Creator/Generator component allows an end-user to create a table of product/service information. The user will be provided with an administrative screen to select the products and product features to include in the matrix. Once the user has selected the matrix parameters, a matrix/table will be generated using Core Data. The user will have the ability to save this configuration for viewing at a later date.

Step-by-step:

The user initiates a new matrix for a particular product type.

A matrix creation screen is created with a matrix identifying all available products and all available product features. The user selects the products and features to include in the matrix

A new record is added to the Matrix table identifying the Matrix name, and relationships are created in the Matrix_Join_User table, Matrix_Join_Fields table, and Matrix_Join_Products table.

The Matrix is generated using the new relationships stored in the database.

If the User decides to save the matrix, the data is maintained, otherwise all new matrix data is deleted from database.

Data Packager

The Data Packager component allows the creation of a downloadable or email-attachable file from any data output. For example, a user creates a Matrix, and wants to publish it on her website. Using the Data Packager, she can create a downloadable copy of the matrix in HTML format with all supporting images included. The Data Packager will generate the file and initiate the download. The Data Packager should be able to create multiple file types such as HTML, Excel spreadsheets, Delimited Text File, Access Database, etc.

Data Qualifier

The Data Qualifier component is a key feature of the mBLAST Gateway. The Qaulifier allows an infinite amount of supporting or meta information to be attached to the Core Data. The meta information facilitated by the Qualifier is another data type that will actually reside in the Core Data tables, and relationships between the supporting data and the Core Data will be provided by the Core_Join_Meta table. Another table called Meta will contain the list of Qualifier data types such as challenge, response, positioning statement, etc

An example of this “qualification” ability of the Gateway is allowing users to challenge the claims made by competitors, and allowing the competitor to respond to this challenge. This exchange will be permanently linked to the actual data value in question, and will be a viewable part of the data value history.

Image Uploader

The Image Uploader Component allows input users to upload images of various file types. These images can be for Company logos, employee portraits, or product shots. The Image Uploader will allow the user to browser their hard drive, select a file, upload the file to a temporary directory, verify the file type, rename the file using a standard naming convention, and move the file to the correct image directory. The Uploader will also add the file path and name to the corresponding Product/Service/Company/Employee Core Data record.

Automated Delta Data Notifier

The Delta Data Notifier allows users to be automatically notified in the event any selected Core Data is modified. A change to the Audit table should trigger a search of all users that have chosen to be modified regarding that data unit. Leveraging the messaging component, the pertinent users will be notified via email, pager, etc. or a notice will be included in their mBLAST Workspace environment. For each flagged data unit, a record will be included in the Delta_Notify table and a relationship to the user will be created with the Delta_Join_User table.

Still In Production

Messaging Component

Data Spider Module

Automated Input Push Module—API connections to mBLAST data core for automated push delivery of data by input clients

Automated Input Pull Module—API connections allowing mBLAST automated retrieval of data from input client databases

Data Spider Module—configurable search agent that spiders internet sources for pertinent data

Automated Access Push Module—API connections to output client databases allowing automated push delivery of mBLAST content

Automated Access Pull Module—API connections to mBLAST data core for automated retrieval of data by output clients

Hosting

The hosting service will leverage the User Interface Data Access Objects utilized by the mBLAST Gateway. An additional object layer will coordinate the administrative aspects of the hosting solution.

Hosting Administrative objects:

Hosting configuration module—could be coded into templates

Branding module—coordinates the branding of the hosted solution to conform to the client site graphics/navigation etc.

mBLAST Application Scenarios

Create/Edit/View Product Categories (mBLAST.org)

Product categories can be defined from multiple sources: some industries have standard product definition codes, such as within the UN/SPSC system, but others, like DSL, do not yet have adequate representation in standardized categorization schemas, so they rely on other product category definitions. Two sources of such definitions, are industry publications and the industry associations and forums. Others may be from RosettaNet and other similar organizations.

mBLAST seeks to have both standardized and non-standard schemas represented. If standardized mappings exist between schemas, mBLAST will adopt those mappings, however, mBLAST will not seek to create mappings between categorizations. Changes, additions, and deletions to the various product category definitions will be considered an alert event. E-mail alerts would be sent to all end users which have associated themselves with a product category. There would be a process to permit the end users to review and change their previous category selections. Changes made to the end users' product category selections, would also be considered an alert event, sending an e-mail alert to all end users having made a previous association with this end user through their product category definitions. Those users, primarily reporters/editors, would have the opportunity to make changes to their associations.

Create Product Categories

End users (Associations/Forums, Publishers) including mBLAST administration, need a process to create new product categorizations. The process for creating a new product categorization scheme is:

Choose the author of the categorization from a list (Network World, DSL Forum, mBLAST)

Choose the industry topic that the categorization belongs to (ATM—Banking, ATM—Networks, DSL, MSP) from an existing list of standard industries (SIC/NAICS)

If no standard industry listing exists for that topic, permit a new industry topic category to be created (multiple industry associations must be permitted.)

If a standard industry is chosen, and a standard product definition exists for that industry, list the likely choices of product category definitions. (Example: if Computers is the industry topic chosen, then there exists a RosettaNet definition for Computers. List only those DTD's that would be pertinent to the computer industry. Based on the choice made in the RosettaNet portion of the page, and if a standard mapping exists between the RosettaNet DTD and a UN/SPSC code, then the UN/SPSC portion of the page would have defaulted to the mapped value for that product/service code, and vice versa.)

If no standard product definition exists, or the existing choices are inadequate, within RosettaNet and/or UN/SPSC, allow the end user to request information from the respective organizations via email.

Allow end user to input multi-level product categories and sub-categories.

Send email alert to associated entities to inform them of the new product category definitions.

E-mail contains URL to a web page of new product categorizations.

Edit Product Categories

End users (Associations/Forums, Publishers) including mBLAST administration, need a process to view/edit existing product categorizations, and a method to add a new product category within an existing category. The process for viewing/editing an existing product categorization scheme is:

Choose the editor of the categorization from a list (Network World, DSL Forum, mBLAST)

Choose the industry topic that the categorization belongs to (ATM—Banking, ATM—Networks, DSL, MSP) from an existing list of standard industries (SIC/NAICS)

View the existing product categorizations.

Add/Edit product categorizations, including inserting a new subcategory within an existing category.

Send email alert to associated entities to inform them of the changed product category definitions.

E-mail contains URL to a web page of all changes, additions, and deletions to the product categorizations.

Selecting Product Categories

End users (Marketing, MarComm, PR Firms) select from as many categorization schemas as they want to be associated with, from all categories that mBLAST has represented for their industry or industries. The process for these users to select their product categories is:

Select product categorizations from those available for the end user's industry associations as represented on input pages, and/or

Select product categorizations from the URL sent when additions/changes are made (see above)

Choose to be alerted when product category definitions are created/edited

When product selection has changed, alert all associated entities.

End users (Reporters/Editors) select their “beats”, or areas of interest, from the list of product categories in mBLAST. The process for these users to select their areas of interest is:

Select areas of interest from those available (i.e., industry(s), product categories, companies) on input pages and/or

Select product categorizations from the URL sent when additions/changes are made (see above)

Choose to be alerted when changes to their areas of interest occur

Create/Edit Survey

Create a New Survey

A survey is a questionnaire that end users can create, and then invite companies to fill out. The process for creating a survey is:

Give the survey a name

Choose default questions for the survey

Define additional questions for the survey

Preview survey, allow edits, additions

Invite companies to fill out the survey (survey cannot be changed after this point)

Allow survey author the ability to choose whether survey respondents can see their answers and those of the other respondents

Display the survey results in presentation formats

Ask if this is a one time or repeat survey

One time surveys can be saved to the Edit Saved Surveys workspace for a limited time

Repeat surveys are saved in the Edit Saved Surveys area of the workspace

Edit a Saved Survey

Editing a saved survey gives the end user the ability to modify which questions are included and which questions are grouped together. The process for editing a survey is:

Preview Chart from the Create New Survey process, or

Choose a previously saved survey from Edit Saved Survey in the workspace, or

Choose Edit Matrix from the chart view,

Choose columns of data to be eliminated from the view, and/or choose columns of data to be grouped together.

Preview survey, allow edits, additions

Invite companies to fill out the survey (survey cannot be changed after this point)

Allow survey author the ability to choose whether survey respondents can see their answers and those of the other respondents

Display the survey results in presentation formats

Ask if this is a one time or repeat survey

One time surveys can be saved to the Edit Saved Surveys workspace for a limited time

Repeat surveys are saved in the Edit Saved Surveys area of the workspace

Edit a System Survey

System surveys are predefined surveys and exist in the mBLAST system, by product category. End users can choose one of these surveys as a “starting point” in their creation process, using the matrix tools to edit the survey. The process for editing a system survey is:

Drill down through a product category to see if a system survey exists

Select existing survey or create new survey (if new go to create new survey process)

Choose Edit Matrix from the chart view,

Choose columns of data to be eliminated from the view, and/or choose columns of data to be grouped together.

Preview survey, allow edits, additions

Invite companies to fill out the survey (survey cannot be changed after this point)

Allow survey author the ability to choose whether survey respondents can see their answers and those of the other respondents

Display the survey results in presentation formats

Ask if this is a one time or repeat survey

One time surveys can be saved to the Edit Saved Surveys workspace for a limited time

Repeat surveys are saved in the Edit Saved Surveys area of the workspace

Save matrix with new name in the authors' workspace

Future Development: Vendor request will determine when a series of repeat questions becomes included in system surveys.

Create/Edit Data Presentation

Create a New Presentation

End users can create a data presentation format based on predefined templates. The process to create/edit a data presentation is:

Create a chart based on a template, choices are:

Buyer's Guide, Company Profile, Links Pages, Directory, Glossary of Terms.

Configure the presentation format from predefined configuration criteria

Generate the chart

Edit a Saved Presentation

End users can choose to use a previously saved presentation format. The process to edit a previously defined format is:

Select a previously saved presentation from the list

Modify the chart by deleting and/or grouping columns

Edit a System Presentation

End users can choose to use a previously defined system presentation as a starting point for their own presentation. These presentations are listed by product category. The process to use a system presentation is:

End user locates the desired product category and drills down to the data presentation which exists for that product.

Modify the chart by choosing Edit Matrix tool; allows deleting/grouping columns.

Note: The basic steps of survey creation/editing and data presentation creation/editing are the same. The distinction between the two needs to be made for the end user.

Browse mBLAST

The browse mBLAST feature is a suite of tools to allow users to search mBLAST data in a variety of ways. There are four basic Browse types: View by Hierarchy, View by Topic, Search Database, and Search by Type.

View by Hierarchy

The View by Hierarchy feature allows the user to browse through a product/service hierarchy, and generate a matrix based on a product category. By clicking on a product category a matrix is automatically generated, and then the user can edit and save the matrix just like any other presentation.

View by Topic

The View by Topic allows the user to find companies by proprietary hierarchies. The View by Topic feature will display all available proprietary hierarchies, possibly by using the Core Hierarchy as a method to search. Once a proprietary hierarchy has been defined, the browse mechanism works in the same way as the View by Hierarchy feature (see above).

Search Database

The Search Database feature is a full-text search engine that can be directed at a variety of data types. The types include:

Corporation Profile

Publication Profile

Editor/Reporter Profile

Product/Service Data

Categorization Headings

Website Address

Logo

Executive Pictures

Direction to Entity

Glossary

Each of these data types searches on a specific subset of the Core Database, and uses one or more fields as the basis of the search. For example, the Corporate Profile Search would only search on Company records, and may use the Company Name, and Company Description fields as the basis of the search. The results are returned in standard search engine format.

Search by Type

The Search by Type feature allows the user to select a data type and then generate a screen display of a single record within the database. The data types available are the same as the Search Database feature (see above). When the user selects a Type, they are then presented with a method to select a specific company or product. The presentation format for that Type is then displayed with the requested data.

Contact Companies

Contact Companies/Reporters/Editors

This tool allows the user to send email to a list of contacts. The user will be able to initialize this feature from several locations. The location where the user selects this tool will determine the contact list that the email will be sent to.

There are two basic ways that a contact list can be generated. The user can either use a data set as the basis for the contact list, or can browse a company-based hierarchy and select a product category or categories from which to include contacts. The user can also choose to enter the contact addresses by hand or select them from their internal mBLAST address book (not yet developed).

To select contacts from a Data Set, the user can select the “Contact Companies” feature within the Data Set tool to contact the companies within that data set, or can select the “Contact” feature from and screen presentation to contact the companies in the presentation. When the user selects the “Contact Companies” option from either location, an Email Form is loaded with the contacts for the data set/presentation loaded into the “To:” area. The user will have the option to select/deselect any contacts in the list, and will also be able to add contacts by hand or from their address book (coming later).

Download Media A user can download a variety of media types: logos, corporate officer images, data files, etc. The process for downloading media is:

start the download media wizard

—identify the type of media to download

—select the product category of interest

—select the companies or products within that category that relate to the desired download media

—download the media to a local hard drive via screen based download mechanism

Edit Profile/Preferences

Edit User Profile/Preferences

The Edit User Profile/Preferences allows individual users to add/modify/delete their user profile and configuration information. There are four pages: Your Profile, Areas of Interest, Company Selections, and Product Selections.

Your Profile

This page allows the user to control their personal information within the system. This includes contact information, company affiliation, etc. It also contains the user's login username and password. This page is created via the Form Editor, and an ASP script handles copying the security information and user name to the login table.

Areas of Interest

The Areas of Interest page presents an input hierarchy that collects a relationship between the user and product categories. These categories become the user's “Areas of Interest” which the user can then track via Delta Data Notification. The user can configure Delta Data Notification options for the Areas of Interest Selected.

Company Selections

The Company Selections page presents an input hierarchy that collects a relationship between the user and companies of interest. The user can then track these companies via Delta Data Notification. The user can configure Delta Data Notification options for the companies Selected.

Product Selections

The Product Selections page presents an input hierarchy that collects a relationship between the user and products of interest. The user can then track these products via Delta Data Notification. The user can configure Delta Data Notification options for the products Selected.

Glossary of Terms

Edit Company Profile

Basic Input Forms

Areas of Interest

Company Selections

Product Selections

View Products

View Current Product Listings

Edit Current Product Listings

Add New Product Listings

Select/Edit Data Sets

Create a New Data Set

Edit an Existing Data Set

Select/Edit Template Formats

Create New Template

Edit Existing Template

Create New Class

Edit Existing Class

Select/Edit Data Feeds

Create New Data Feed

Edit Existing Data Feed

Select/Edit Presentation

Create New Presentation

Edit Existing Presentation

Hosted Pages

Create New Hosted Page

Edit Existing Hosted Page

Member List

Create New Member List

Edit Existing Member List

Select Company to Edit (PR Firms)

Search Functions

Messaging

Inbox

Read Message

Create Message

Survey Tracking

Saved Presentation Tracking

Programming API

mBData API

CData Class:

If the GetConnectString method is used it requires the following entries in the INI file that is passed in as an argument. Alternatively, the calling program can supply it's own ConnectString without using the GetConnectString method.

[Database]
Driver={SQL Server}
Server=DBServer
UID=
PWD=
DatabaseName=DB

Dependant Classes

mBUtilities.CMsgLog

mBUtilities.CIni

Properties

IniPath—String identifying the path of the INI file containing the ConnectString parameters.

MsgLogPath—String identifying the path of the Message Log where errors are written.

NodeName—String identifying the computer name used when writing to the Message Log.

Conn—The ADO Connection object used to perform the different methods.

CursorLocation—(Optional) Long identifying the location of the Cursor. Must be set prior to opening the connection. Acceptable values:

adUseClient

adUseServer

CursorType—(Optional) Long identifying the Type of Cursor to use. Must be set prior to creating the ADO Recordset. Acceptable values:

adOpenForwardOnly

adOpenKeyset

adOpenDynamic

adOpenStatic

CursorLockType—(Optional) Long identifying the Cursor Lock Type to use. Must be set prior to creating the ADO Recordset. Acceptable values:

adLockReadOnly

adLockPessimistic

adLockOptimistic

adLockBatchOptimistic

Methods

GetConnectString (strIniPath As String) As String—Returns the connect string used to open an ADO connection.

OpenConn (strConnectString As String, Conn1 As ADODB.Connection) As Boolean—Opens an ADO connection and returns True if successful.

CloseConn (Conn As ADODB.Connection) As Boolean—Closes an ADO connection and returns True if successful.

ExecuteSP (Conn As ADODB.Connection, strSPName As String, ParamArray spParameters()) As Boolean—Executes a stored procedure named strSPName. The stored procedure can include a variable number of parameters included in the ParamArray. Each element of the ParamArray should be in the format ParameterType, Parameter Size, Parameter Value. This method returns True if the stored procedure was executed successfully.

ReturnSPResults (Conn As ADODB.Connection, strSPName As String, ParamArray spParameters()) As ADO.Recordset—Executes a stored procedure named strSPName. The stored procedure can include a variable number of parameters included in the ParamArray. Each element of the ParamArray should be in the format ParameterType, Parameter Size, Parameter Value. This method returns the ADO.Recordset returned by the stored procedure.

ExecuteSQL (Conn As ADODB.Connection, strSQL As String) As Boolean—Executes the SQL statement contained in strSQL. This method returns True if the SQL executed successfully.

ReturnSQLResults (Conn As ADODB.Connection, strSQL) As ADO.Recordset—Executes the SQL statement contained in strSQL. This method returns the ADO.Recordset returned by the SQL statement.

### mBForm API

Summary:

The mBForm component is specifically designed to contain the business logic necessary to build a single HTML form. The mBForm component is not meant to be used by itself, but rather as a collection used to build a Form Group. A Form Group may consist of one or more Forms.

CForm Class:

Creates, Displays, Modifies, or Copies an HTML form.

Dependant Classes:

The mBForm component depends on the following components in order to function.

mBData.CData

mBUtilities.CIni

mBUtilities.CMsgLog

Input.CInput

Properties

MsgLogPath—String. The path of the Message Log where errors are written.

NodeName—String. The computer name used when writing to the Message Log.

IniPath—String. The path to this components INI file.

Name—String. The name of the form.

FileName—String. The filename where the form is written.

ID—Long. The ID of the form.

FormInputID—Long. The ID of the Input

Order—Integer. The order the Input is displayed.

Cell—String. The cell on the form where the input is displayed.

Methods

Add()—Adds a new Input to the database.

Delete()—Deletes an Input from the database.

Fetch()—Fetches the Input from the database.

Update()—Updates the Input in the database.

SaveAs()—Saves the current Form with a different name.

Generate()—Generates an ASP file whenever changes are made to a Form.

### mBForms API

Summary:

The mBForms component is specifically designed to contain the business logic necessary to build a group of related HTML forms. The mBForms component is not meant to be used by itself, but rather as a collection used to build a Product or Service. A Product or Service may consist of one or more Form Groups.

CFormGroup Class:

Creates, Displays, Modifies, or Copies a Form Group.

Dependant Classes:

The mBForms component depends on the following components in order to function.

mBData.CData

mBUtilities.CIni

mBUtilities.CMsgLog

mBInput.CInput

mBForm.CForm

Properties

MsgLogPath—String. The path of the Message Log where errors are written.

NodeName—String. The computer name used when writing to the Message Log.

IniPath—String. The path to this components INI file.

Name—String. The name of the Form Group.

ID—Long. The ID of the Form Group.

FormID—Long. The ID of the Form.

Order—Integer. The order the Input is displayed.

Methods

Add()—Adds a new Input to the database.

Delete()—Deletes an Input from the database.

Fetch()—Fetches the Input from the database.

Update()—Updates the Input in the database.

SaveAs()—Saves the current Form with a different name.

### mBInput API

Summary:

The mBInput component is specifically designed to contain the business logic necessary to build a single input to be used in an HTML form. The mBInput component is not meant to be used by itself, but rather as a collection used to build an entire HTML form.

CInput Class:

Creates, Displays, Modifies, or Copies an Input.

Dependant Classes:

The mBInput component depends on the following components in order to function.

mBData.Cdata

mBUtilities.Cini

mBUtilities.CMsgLog

Properties

MsgLogPath—String. The path of the Message Log where errors are written.

NodeName—String. The computer name used when writing to the Message Log.

IniPath—String. The path to this components INI file.

QuestionNum—Integer. The Question Number of this input

FieldNameID—Long. The Key used to look up the FieldName in the Fields table.

InputType—Integer. The type of input this is.

Size—Integer. The size of this input.

ValidationRule—Integer. The Validation Rule that should be performed on this input when the form is submitted.

InputGroup—String. The name of the InputGroup this input belongs to (radio buttons only).

Name—String. The name of this input.

Value—String. The value assigned to this input.

MaxLength—Integer. The MaxLength allowed for this input.

Checked—Boolean. True if this input is checked (checkboxes and radio buttons only)

Selected—Boolean. True if this input is selected (drop down boxes only)

Multiple—Boolean. True if this input allows multiple selections (drop down boxes only)

Src—String. The path of an image to be used for this input. (submit buttons only)

Alt—String. Text supplied to an image to be displayed until image is downloaded, and on mouseover.

Width—String. The width of this input.

Height—String. The height of this input.

Rows—Integer. The number of rows in this input. (Text Area only)

Cols

Integer. The number of columns in this input. (Text Area only)

Wrap—Boolean. True if the text in this input is allowed to wrap.

Font—String. The font to use for this input.

Table—String. The name of the table where the value of this input is written in the database.

FieldName—String. The name of the table where the value of this input is written in the database.

Column—String. The name of the table where the value of this input is written in the database.

FormID—Long. The Form ID of the form where this input is located.

Methods

Add()—Adds a new Input to the database.

Delete()—Deletes an Input from the database.

Fetch()—Fetches the Input from the database.

Update()—Updates the Input in the database.

SaveAs()—Saves the current Input with a different name.

Public Enumerations (Constants available to all programs which reference this object)

Type InputTypes

Text = 1
Password = 2
Checkbox = 3
Radio = 4
Image = 5
Hidden = 6
Select = 7
TextArea = 8
Submit = 9
Reset = 10
None = 99

End Type

### mBProduct API

Summary:

The mBProduct component is specifically designed to contain the business logic necessary to build a group of related HTML Form Groups. The mBProduct component is the topmost component necessary to create a Product or Service.

CForms Class:

Creates, Displays, Modifies, or Copies a Product.

Dependant Classes:

The mBProduct component depends on the following components in order to function.

mBData.CData

mBUtilities.CIni

BUtilities.CMsgLog

mBInput.CInput

Form.CForm

mBForms.CForms

Properties

MsgLogPath—String. The path of the Message Log where errors are written.

NodeName—String. The computer name used when writing to the Message Log.

IniPath—String. The path to this components INI file.

Name—String. The name of the Form Group.

ID—Long. The ID of the Form Group.

FormGroupID—Long. The ID of the Form Group.

Methods

Add()—Adds a new Input to the database.

Delete()—Deletes an Input from the database.

Fetch()—Fetches the Input from the database.

Update()—Updates the Input in the database.

SaveAs()—Saves the current Form with a different name.

### mBUtilities API

Summary:

The mBUtilities component contains general purpose utilities that can be used by other programs or components. Listed below are the functions currently contained in mBUtilities. However, new functions may be added when the need arises.

I. Read/Write to an INI file.

II. Write to a Message Log.

CIni Class:

Reads/writes data from/to an INI file.

Dependant Classes

None

Properties

MsgLogPath—String identifying the path of the Message Log where errors are written.

NodeName—String identifying the computer name used when writing to the Message Log.

Methods

Read(ByVal strSectionName As String, ByVal strEntryName As String, ByRef strReturnString As String, ByVal strIniPath As String) As Boolean—Reads the data associated with the key strEntryName in the section strSectionName from the INI file specified in strIniPath. If successful, this method returns True and sets the parameter strReturnString equal to the data read from the file.

Write(Incomplete) As Boolean

CMsgLog Class:

Writes a message to an ASCII log file. Given the path the file is created if it does not exist, otherwise, the message is appended to the existing file. If the path doesn't exist the default is C:\. Additionally, the function will fix the path to add a \ to the end of the path if not present. The filename is created in the format YYMMDD.TXT. The message is written in the format:

ErrorLevel) Time Requestor ErrorMessage

Example

2) 03:26:58 pm WSDatal ExecuteSP Error=The specified stored procedure does not exist.

Dependant Classes

None

Properties

None

Methods

WriteLog(ByVal strRequestor As String, ByVal strMsgLogPath As String, ByVal strErrorMessage As String, ByVal intErrorLevel As Integer)—Does not return anything

Public Enumerations (Constants available to all programs which reference this object)

ML_CRITICAL=1

ML_MINOR=2

Components

### Bulk Feed Component

Description: The Bulk Feed Component is the companion to the Hosted Pages Component. These components are responsible for configuring the delivery options for Data Presentations; Hosted Pages Component for HTML presentations, Bulk Feed Component for Bulk Feed presentations.

The Bulk Feed interface allows the user to select a saved Bulk Feed presentation, and determine the schedule and method for delivery of that data. The schedule information is used by the Delta Data/Chron Components to determine when the delivery should be executed.

The Bulk Feed component consists of an ASP user interface and a COM component. The user interface will collect the necessary information from a particular user about the type of data set they wish to receive, the method they wish to have it delivered, and the frequency for receiving bulk data.

Technical Details: The ASP interface should contain the minimum amount of business logic, and should not interact directly with the database. The COM component (mBBulkFeed.dll) should contain all the necessary business logic and database interaction required to configure a data set. Whenever possible, embedded SQL should be avoided and stored procedures should be used.

Process: Within the user's workspace, the user will be given the option to create, modify, or delete a data set. If the user has defined data sets, they will be given the option of configuring a data feed for each data set.

Once configured, a record will be written to the Schedule tables where the Chron component will take over. See the Chron and Process Manager component specifications to determine how to populate the Schedule tables.

Tables:

| | |
|---|---|
| BulkFeed - | Main table containing the user, data set, |
| | bulk feed type, and delivery method. |
| BulkFeedTypes - | Contains the possible types of data that |
| | can be received. (XML, HTML, |
| | Excel, etc.) |
| BulkFeedMethods - | Contains the possible deliver methods. |
| | (Download, Email, etc.) |
| Components - | Contains a list of all components used by |
| | Chron component. |
| ComponentParameters - | Contains a list of parameters used by |
| | each component. |
| ComponentTaskParameters - | Contains the actual parameter values that |
| | should be set for a particular task. |
| Schedule - | Contains a list of schedules to be ran. |
| ScheduleDetails - | Contains a list of tasks associated with |
| | each schedule. |
| ScheduleTasks - | Contains the component required to carry |
| | out each task. |

Table Definitions:

| | | |
|---|---|---|
| BulkFeed | | |
| BulkFeedId | int | An identity field containing a unique number for each BulkFeed |
| | | record |
| BulkFeedTypeId | int | Number representing the type of bulk feed |
| BulkFeedMethodId | tinyint | Number representing the method used to deliver the data |
| DataSetId | int | Number representing the data set to be sent to the user |
| UID | varchar | Number representing the type of change that occurred in the data |
| CreatedDTS | datetime | Timestamp when the bulk feed configuration was created |
| LastModifiedDTS | datetime | Timestamp when the bulk feed configuration was last modified |
| BulkFeedTypes | | |
| BulkFeedTypeId | int | An identity field containing a unique number for each type of bulk |
| | | feed |
| Name | varchar | Name of the type of bulk feed |
| BulkFeedMethods | | |
| BulkFeedMethodId | int | An identity field containing a unique number for each bulk feed |
| | | method |
| Name | varchar | Name of the bulk feed method |
| Components | | |
| ComponentId | int | An identity field containing a unique number for each component |
| Name | varchar | The name of this component |
| ComponentParameters | | |
| ComponentItemId | int | An identity field containing a unique number for each Component Item |
| Name | varchar | The name of this Component Item |
| ComponentTaskParameters | | |
| ComponentId | int | Number representing the parent Component |
| TaskId | int | Number representing the parent Task |
| UID | int | Number representing the user this Schedule is associated with |
| ComponentItemId | int | Number representing the parent Component Item |
| Value | varchar | The value for this Component Item |
| Schedule | | |
| ScheduledID | int | An identity field containing a unique number for each schedule |
| Name | varchar | The name of this schedule |
| Interval | int | Number of minutes until schedule should run again |
| Status | int | Completion status of the entire schedule |
| | | 0 = New, 1 = In Process, 2 = Complete, 3 = Error |
| CreatedDTS | datetime | Timestamp when the schedule was created |
| LastRanDTS | datetime | Timestamp when the schedule was last ran |
| ScheduleDetails | | |
| ScheduleID | int | Number representing the parent Schedule |
| SeqNum | tinyint | Counter for each Task included in this Schedule |
| TaskId | int | Number representing the parent Task |
| Status | int | Completion status for this Task |
| ScheduleTasks | | |
| TaskId | int | An identity field containing a unique number for each Task |
| Name | varchar | The name of this Task |
| ComponentId | smallint | Number representing the component that will execute this Task |

### Bulk Feed Component

Description: The Bulk Feed Component is the companion to the Hosted Pages Component. These components are responsible for configuring the delivery options for Data Presentations; Hosted Pages Component for HTML presentations, Bulk Feed Component for Bulk Feed presentations.

The Bulk Feed interface allows the user to select a saved Bulk Feed presentation, and determine the schedule and method for delivery of that data. The schedule information is used by the Delta Data/Chron Components to determine when the delivery should be executed.

The Bulk Feed component consists of an ASP user interface and a COM component. The user interface will collect the necessary information from a particular user about the type of data set they wish to receive, the method they wish to have it delivered, and the frequency for receiving bulk data.

Technical Details: The ASP interface should contain the minimum amount of business logic, and should not interact directly with the database. The COM component (mBBulkFeed.dll) should contain all the necessary business logic and database interaction required to configure a data set. Whenever possible, embedded SQL should be avoided and stored procedures should be used.

Process: Within the user's workspace, the user will be given the option to create, modify, or delete a data set. If the user has defined data sets, they will be given the option of configuring a data feed for each data set.

Once configured, a record will be written to the Schedule tables where the Chron component will take over. See the Chron and Process Manager component specifications to determine how to populate the Schedule tables.

Tables:

| | |
|---|---|
| BulkFeed - | Main table containing the user, data set, |
| | bulk feed type, and delivery method. |
| BulkFeedTypes - | Contains the possible types of data that |
| | can be received. (XML, HTML, Excel, |
| | etc.) |
| BulkFeedMethods - | Contains the possible deliver methods. |
| | (Download, Email, etc.) |
| Components - | Contains a list of all components used by |
| | Chron component. |
| ComponentParameters - | Contains a list of parameters used by each |
| | component. |
| ComponentTaskParameters - | Contains the actual parameter values that |
| | should be set for a particular task. |
| Schedule - | Contains a list of schedules to be ran. |
| ScheduleDetails - | Contains a list of tasks associated with |
| | each schedule. |
| ScheduleTasks - | Contains the component required to carry |
| | out each task. |

Table Definitions:

| | | |
|---|---|---|
| BulkFeed | | |
| BulkFeedId | int | An identity field containing a unique number for each BulkFeed |
| | | record |
| BulkFeedTypeId | int | Number representing the type of bulk feed |
| BulkFeedMethodId | tinyint | Number representing the method used to deliver the data |
| DataSetId | int | Number representing the data set to be sent to the user |
| UID | varchar | Number representing the type of change that occurred in the data |
| CreatedDTS | datetime | Timestamp when the bulk feed configuration was created |
| LastModifiedDTS | datetime | Timestamp when the bulk feed configuration was last modified |
| BulkFeedTypes | | |
| BulkFeedTypeId | int | An identity field containing a unique number for each type of bulk |
| | | feed |
| Name | varchar | Name of the type of bulk feed |
| BulkFeedMethods | | |
| BulkFeedMethodId | int | An identity field containing a unique number for each bulk feed |
| | | method |
| Name | varchar | Name of the bulk feed method |
| Components | | |
| ComponentId | int | An identity field containing a unique number for each component |
| Name | varchar | The name of this component |
| ComponentParameters | | |
| ComponentItemId | int | An identity field containing a unique number for each Component Item |
| Name | varchar | The name of this Component Item |
| ComponentTaskParameters | | |
| ComponentId | int | Number representing the parent Component |
| TaskId | int | Number representing the parent Task |
| UID | int | Number representing the user this Schedule is associated with |
| ComponentItemId | int | Number representing the parent Component Item |
| Value | varchar | The value for this Component Item |
| Schedule | | |
| ScheduleID | int | An identity field containing a unique number for each schedule |
| Name | varchar | The name of this schedule |
| Interval | int | Number of minutes until schedule should run again |
| Status | int | Completion status of the entire schedule |
| | | 0 = New, 1 = In Process, 2 = Complete, 3 = Error |
| CreatedDTS | datetime | Timestamp when the schedule was created |
| LastRanDTS | datetime | Timestamp when the schedule was last ran |
| ScheduleDetails | | |
| ScheduledID | int | Number representing the parent Schedule |
| SeqNum | tinyint | Counter for each Task included in this Schedule |
| TaskId | int | Number representing the parent Task |
| Status | int | Completion status for this Task |
| ScheduleTasks | | |
| TaskId | int | An identity field containing a unique number for each Task |
| Name | varchar | The name of this Task |
| ComponentId | smallint | Number representing the component that will execute this Task |

### Chron Engine

Description: This component is responsible for querying the Schedule table and perform the tasks listed there.

Properties:

UserId

TaskId

Recurring

Initial Task Capabilities:

Saved Matrix

Survey

Hosted Presentation

Data Feed

Product Categories

Companies

### Compression Component

Description: This component is responsible for accepting raw data and compressing and/or encrypting the data.

Properties:

CompressionType

EncryptionType

InputPath

OutputPath

Public Enum: Used for CompressionType.

COMP_NONE = 0
COMP_ZIP = 1
COMP_TAR = 2
Public Enum: Used for EncryptionType
ENC_NONE = 0
ENC_PGP = 1

### DataFormat Component

Description: This component is responsible for formatting raw data into a presentation format that is pre-defined by the user. The component reads an XML file, and writes a file of the type specified in the presentation. These file types may include: ASCII, XML, ASP, HTML, Excel, Access, etc.

Technical Details: There is no ASP interface for this component. The user interface for configuring the presentation format will be handled by the DataPresentation Component. The COM component (mBDataFormat.dll) should contain all the necessary business logic and database interaction required to read an XML file, and convert the XML file to the specified format. Whenever possible, embedded SQL should be avoided and stored procedures should be used. It may be desirable to have sub-components responsible for converting each different PresentationType and/or PresentationClass. Additional PresentationTypes and PresentationClasses will be added in the future, so the program should be written with this in mind.

Process: This component may be called by an ASP page, or another COM component. The UID and DataFormatId will be supplied. The component will query the DataFormat table. Based on the PresentationId, the component will retrieve the necessary information from the Presentation and any other tables depending on the information contained in the Presentation table. The component will then use this information to convert the XML file into the specified format and write that file to disk.

If the PresentationType is HTML or ASP, a Template may be associated with the presentation containing HTML specific options. In addition, a header and/or footer to be included may also be specified.

Properties:

UID—The UserId of the person formatting this data.

InputPath—The complete path to the XML file.

FormatID—The FormatID to be used in this conversion.

OutputPath—The complete path where the output file should be written.

PresentationTypeID—The type of presentation to be added to the data. (ASCII, HTML, etc.)

PresentationClassID—The class of presentation to generate. (Matrix, Link List, etc.)

Methods:

Generate—Begins the conversion process.

Tables: (These tables should be used as a starting point. They may be modified as necessary, however, these modifications should be coordinated with the person(s) working on the Presentation Editor.)

DataFormat—The table containing the DataFormat to be used.

Template—If required, the table containing the Template to be used.

TemplateDetails—The details about the Template.

TemplateItems—Items that may be configured by this Template.

Presentation—The Presentation to apply to the data.

PresentationTypes—The type of Presentation. (ASCII, HTML, etc.)

PresentationClasses—The Presentation Class. (Matrix, Link List, etc.)

PresentationDetails—The details of the Presentation

IncludeFiles—Header and/or Footer files that will be included in the Presentation.

Table Definitions:

| | | |
|---|---|---|
| DataFormat | | |
| DataFormatId | int | An identity field containing a unique number for each Data Format |
| Name | varchar | A user specified name for this Data Set |
| PresentationId | int | A number representing the record in the Presentation table. |
| PresentationClassId | int | A number representing the record in the PresentationClasses table. |
| UID | int | The UID of the user that created this Data Set |
| InputPath | varchar | The complete path to the XML file to be read |
| OutputPath | varchar | The complete path where the output file will be written. |
| CreatedDTS | datetime | Timestamp when the Data Format was created |
| RevisedDTS | datetime | Timestamp when the Data Format was last modified |
| Templates | | |
| TemplateId | int | An identity field containing a unique number for each Template |
| Name | varchar | A user specified name for this Template |
| UID | int | The UID of the user that created this Template |
| CreatedDTS | datetime | Timestamp when the Template was created |
| RevisedDTS | datetime | Timestamp when the Template was last modified |
| TemplateDetails | | |
| TemplateId | int | A number representing the parent record |
| SeqNum | smallint | Counter for each record included in the TemplateId |
| TemplateItemId | int | Number representing the item the corresponding values applies to |
| Value | varchar | Value of this TemplateItem |
| TemplateItems | | |
| TemplateItemId | int | An identity field containing a unique number for each TemplateItem |
| Name | varchar | The name of this TemplateItem |
| Presentation | | |
| PresentationId | int | An identity field containing a unique number for each Presentation |
| Name | varchar | A user specified name for this Presentation |
| UID | int | The UID of the user that created this Presentation |
| CreatedDTS | datetime | Timestamp when the Presentation was created |
| RevisedDTS | datetime | Timestamp when the Presentation was last modified |
| PresentationTypes | | |
| PresentationTypeId | int | An identity field containing a unique number for each PresentationType |
| Name | varchar | The name of this PresentationType |
| PresentationDetails | | |
| PresentationId | int | Number representing the parent Presentation |
| PresentationTypeId | int | Number representing the type of Presentation this record applies to |
| SeqNum | smallint | Counter for the records included in this Presentation |
| TableId | smallint | Number representing the table where the information about this |
| | | PresentationType can be found |
| KeyValue | varchar | Number representing the particular record where the information can be |
| | | found |
| PresentationClasses | | |
| PresentationClassId | int | An identity field containing a unique number for each PresentationClass |
| Name | varchar | The name of this PresentationClass |
| IncludeFiles | | |
| IncludeId | int | An identity field containing a unique number for each Include File |
| Name | varchar | A user specified name for this Include File |
| UID | int | The UID of the user that created this Include File |
| Path | varchar | The complete path to the include file |
| Location | smallint | A number representing where this file should be included in the ASP file |
| CreatedDTS | datetime | Timestamp when the Include File was created |
| RevisedDTS | datetime | Timestamp when the Include File was last modified |

### Data Presentation Components

Description: The Data Presentation Component is actually a family of components and ASP interfaces that are responsible for creating configurations that facilitate the formatting of all data output. The Data Presentation group allows the user to create configurations for two basic Presentation types: HTML and Bulk Data.

There are two sub-categories of HTML presentations; XML/XSL based presentations and HTML presentations. The XML/XSL based presentation type allows mBLAST-hosted presentations, including Workspace-based screen displays and Hosted Pages, to make use of the dynamic qualities of XML/XSL driven documents. Also, any customers that can support XML/XSL documents can have presentations delivered to them in this format. For users who can not support XML/XSL or who wish to have a standard HTML document delivered to them for other reasons, presentations are also available as standard HTML. This format, however, does not inherit the dynamic capabilities of the XML source document.

The Data Presentation group supports user-defined look and feel for HTML/XML presentation formats. Users can modify an HTML/XML presentation in three basic ways; changes to the style of the presentation similar to Cascading Style Sheets, changes to the presentation format itself i.e. which fields will be displayed, what icons to use, etc., and the addition of header and footer code for each presentation page that allows the user to brand the page with a specific look and feel, navigation, logo, etc.

Bulk Data presentation formats include XML, ASCII, Excel, Access, etc. These Bulk Data formats can also be configured to varying degrees, depending on the output format.

The process for creating a presentation is as follows:

First the user defines a Data Set, which is a meta-data configuration of a desired sub-set of the mBLAST Core Data. The Data Set is dynamic in that it stores general parameters for defining a data set, but does not identify specific data. Therefore the Data Set contains the most current data in the system even if relevant records have been added/changed/deleted since the Data Set was created.

Once the Data Set has been defined, the user has the option to create one or more presentations based on that Data Set. These presentations are actually separate configurations that define how the Data Set should be formatted. Presentations and Data Sets can be modified independently of each other; however, if changes to the Data Set affect an existing Presentation (for example, if the user removes a field from a Data Set that is used as part of a Presentation) the user should be notified of the dependency. (There has been no decision yet as to how to handle dependencies in presentations for Data Set criteria that have been deleted.)

The user can choose either HTML or Bulk Data presentation types. If the user selects the HTML presentation type, then there are three configuration options available; Templates, Classes, and Headers/Footers. The Templates are similar to Cascading Style Sheets, the Classes are the various presentation formats i.e. Matrix, Link List, Company Profile, etc, and the Headers/Footers are HTML code that is inserted at the top and/or bottom of the HTML presentation. (Classes should be infinitely configurable using web-based wizards. The standard Classes are suggested presentation formats that should suit most users with often only minor modifications required) These presentation options are also independent configurations; they can be modified independently of presentations, and can be used on multiple presentations. When creating an HTML presentation the user can select to have the presentation generated as standard HTML or as XML/XSL. The user can select to have the HTML presentations displayed on the screen, delivered immediately via browser download, FTP or email, or delivered on a scheduled basis. The scheduled delivery of HTML presentations is done through the Hosted Page Component, which is available both as a stand-alone tool and integrated into the HTML presentation interface. This Component allows the user to configure the method and delivery schedule of HTML presentations.

If the user selects the Bulk Data presentation type, there are a variety of Bulk Data formats to choose from, including ASCII, XML, Access, Excel, etc. The Bulk Data presentation is somewhat different from the HTML presentation type in that, by nature it is a type of Data Feed. There is no option for displaying Bulk Data presentations on the screen; if a user creates a Bulk Data presentation then they wish to have it delivered to them by some method. Therefore the Bulk Data presentation configuration also allows the user to define the delivery method including immediate delivery methods such as browser-based download, FTP and email delivery, and scheduled deliveries by various methods including email and FTP. This is done through the Bulk Feed component which is available as a stand-alone tool and integrated into the Bulk Data presentation interface.

The various features of the Data Presentation Group are facilitated by calling the following components:

Template Component—Allows the user to pick an existing template, edit an existing template, or create a new template to configure the appearance of the HTML.

PresentationClass Component—Assigns a presentation class to the configuration. Each presentation class will have it's own rules for displaying the information. The user should only be allowed to select an existing presentation class, and add additional information (if any) for how this particular presentation class should be displayed. MBlast administrators, should be allowed to create new presentation classes or modify existing presentation classes.

IncludeFile Component—Allows the user to select a header/footer, edit and existing header/footer, or create a new header/footer to be included in their presentation.

BulkDataConfig Component—Allows the user to configure the Data Set in one of several Bulk Data formats including: ASCII, XML, HTML, etc.

The combination of configuration data collected from each of these components will constitute a unique Presentation, and references to this data will be stored in the Presentation and PresentationDetails tables. Each component should check for the existence of a record in the Presentation table for this presentation, and insert a new record if necessary. In addition, each component should add a reference to the configuration data it collected from the user, and write this information to the PresentationDetails table.

Template Component Properties:

Templateld—The template to be used.

Name—The user-specified name of the template.

UID—The UserId of the person creating or modifying the template.

TemplateItem—The particular item in the template being created or modified.

Value—The value of the TemplateItem.

PresentationId—Used for referencing the record(s) contained in the PresentationDetails table.

Template Component Methods:

Add—Create a new template.

Update—Modify an existing template.

Delete—Delete an existing template.

SaveAs—Make a copy of the template, and save it with another name.

PresentationClass Component Properties:

PresentationClassId—The presentation class to be used.

Name—The mBlast-specified name of the presentation class.

UID—The UserId of the person creating or modifying the presentation class.

PresentationClassItemId—The additional configuration item for this presentation class.

Value—The value of the configuration item supplied by the user.

PresentationId—Used for referencing the record(s) contained in the PresentationDetails table.

PresentationClass Component Methods:

Add—Create a new presentation class.

Update—Modify an existing presentation class.

Delete—Delete an existing presentation class.

SaveAs—Make a copy of the presentation class, and save it with another name.

AddItem—Add a new item to be used for additional presentation class configuration items.

UpdateItem—Update an existing item to be used for additional presentation class configuration items.

DeleteItem—Delete an existing item to be used for additional presentation class configuration items.

AddItemValue—Add the user supplied value for additional presentation class configuration items.

UpdateItemValue—Update the user supplied value for additional presentation class configuration items.

DeleleItemValue—Delete the user supplied value for additional presentation class configuration items.

IncludeFile Component Properties:

Includeld—The include file to be used.

Name—The user-specified name of the include file.

UID—The UserId of the person creating or modifying the include file.

Location—Where the include file should be included. (Header/Footer)

Text—The text to be written to the include file.

Path—The complete path where the include file should be written.

PresentationId—Used for referencing the record(s) contained in the PresentationDetails table.

IncludeFile Component Methods:

Add—Create a new include file.

Update—Modify an existing include file.

Delete—Delete an existing include file.

SaveAs—Make a copy of the include file, and save it with another name.

BuLkData Component: (properties and methods to be determined)

Tables: (These tables should be used as a starting point. They may be modified as necessary, however, these modifications should be coordinated with the person(s) working on the Data Formatting Component.)

DataFormat—The table containing the DataFormat to be used.

Template—If required, the table containing the Template to be used.

TemplateDetails—The details about the Template.

TemplateItems—Items that may be configured by this Template.

Presentation—The Presentation to apply to the data.

PresentationTypes—The type of Presentation. (ASCII, HTML, etc.)

PresentationDetails—The details of the Presentation

PresentationClasses—The Presentation Class. (Matrix, Link List, etc.)

PresentationClassDetails—The details of the Presentation Class. These are the items the user may configure.

PresentationClassItems—Items that can be configured by the user for each Presentation Class.

IncludeFiles—Header and/or Footer files that will be included in the Presentation.

Table Definitions:

| | | |
|---|---|---|
| DataFormat | | |
| DataFormatId | int | An identity field containing a unique number for each Data Format |
| Name | varchar | A user specified name for this Data Set |
| PresentationId | int | A number representing the record in the Presentation table. |
| PresentationClassId | int | A number representing the record in the PresentationClasses table. |
| UID | int | The UID of the user that created this Data Set |
| InputPath | varchar | The complete path to the XML file to be read |
| OutputPath | varchar | The complete path where the output file will be written. |
| CreatedDTS | datetime | Timestamp when the Data Format was created |
| RevisedDTS | datetime | Timestamp when the Data Format was last modified |
| Templates | | |
| TemplateId | int | An identity field containing a unique number for each Template |
| Name | varchar | A user specified name for this Template |
| UID | int | The UID of the user that created this Template |
| CreatedDTS | datetime | Timestamp when the Template was created |
| RevisedDTS | datetime | Timestamp when the Template was last modified |
| TemplateDetails | | |
| TemplateId | int | A number representing the parent record |
| SeqNum | smallint | Counter for each record included in the TemplateId |
| TemplateItemId | int | Number representing the item the corresponding values applies to |
| Value | varchar | Value of this TemplateItem |
| TemplateItems | | |
| TemplateItemId | int | An identity field containing a unique number for each TemplateItem |
| Name | varchar | The name of this TemplateItem |
| Presentation | | |
| PresentationId | int | An identity field containing a unique number for each Presentation |
| Name | varchar | A user specified name for this Presentation |
| UID | int | The UID of the user that created this Presentation |
| CreatedDTS | datetime | Timestamp when the Presentation was created |
| RevisedDTS | datetime | Timestamp when the Presentation was last modified |
| PresentationTypes | | |
| PresentationTypeId | int | An identity field containing a unique number for each PresentationType |
| Name | varchar | The name of this PresentationType |
| PresentationDetails | | |
| PresentationId | int | Number representing the parent Presentation |
| PresentationTypeId | int | Number representing the type of Presentation this record applies to |
| SeqNum | smallint | Counter for the records included in this Presentation |
| TableId | smallint | Number representing the table where the information about this |
| | | PresentationType can be found |
| KeyValue | varchar | Number representing the particular record where the information can be |
| | | found |
| PresentationClasses | | |
| PresentationClassId | int | An identity field containing a unique number for each PresentationClass |
| Name | varchar | The name of this PresentationClass |
| PresentationClassDetails | | |
| PresentationClassId | int | Number representing the parent PresentationClass |
| SeqNum | varchar | Counter used for each record belonging to this PresentationClass |
| PresentationClassItemId | | Number representing the Item to which the value corresponds |
| Value | | The value for this item |
| PresentationClassItems | | |
| PresentationClassItemId | int | Number representing the Item to which the value corresponds |
| Name | varchar | The name of this PresentationClassltem |
| IncludeFiles | | |
| IncludeId | int | An identity field containing a unique number for each Include File |
| Name | varchar | A user specified name for this Include File |
| UID | int | The UID of the user that created this Include File |
| Path | varchar | The complete path to the include file |
| Location | smallint | A number representing where this file should be included in the ASP file |
| CreatedDTS | datetime | Timestamp when the Include File was created |
| RevisedDTS | datetime | Timestamp when the Include File was last modified |

### DataSet Component

Description: This component is responsible for collecting and storing all the configuration information necessary to define a subset of data contained within the Core data tables. It should consist of an ASP interface and a COM component.

Technical Details: The ASP interface should contain the minimum amount of business logic, and should not interact directly with the database. The COM component (mBDataSet.dll) should contain all the necessary business logic and database interaction required to configure a data set. Whenever possible, embedded SQL should be avoided and stored procedures should be used.

Process: Within the user's workspace, the user will be given the option to create, modify, or delete a data set. If the user has no previously defined data sets, the modify and delete options will be hidden.

When a user elects to create a data set, an ASP interface will be displayed. The user will select the type of data set they wish to create from the available DataSetTypes. Additional DataSetTypes will be added in the future, so this should be taken into consideration when designing and programming the Data Set Component.

Matrix Data Set Type:

When a user elects to create a Matrix type data set, the user will be shown a form presenting the available FormGroups to which the user has the necessary security rights to display. Additionally, if the user has existing data sets, they will be given the option of creating a new data set based on an existing data set. Essentially, this is making a copy of an existing data set, and then allowing them to edit this newly saved data set.

Within each FormGroup, the user will be given the option of including all Forms, or be given the option of selecting each Form to be included individually. Within each Form, the user will be given the option of including all questions, or selecting each question to be included individually. Also, the user will be given the option of including all meta data, or selecting the meta data for each question individually.

Based on the user's selections throughout the process, the data set information will be written to the DataSet and DataSetDetails tables. This information must include everything necessary for the BulkData component to extract all the desired data from the Core tables. The DataSet table will include general information about the DataSet. The DataSetDetails table will contain the actual details of the Core data to be extracted. For Matrix types, this information will minimally include one record for each Form with the FormQuestionId set to 0, signifying that all questions within this Form should be included. If the user elected to specify each individual question to be included, then there will be a record for each FormQuestionId that should be included in the data set.

Additional Data Set Types:

Specifications for additional data set types will be provided at a later time.

The process of modifying an existing data set should be identical to creating a data set, except all information within the ASP interface, should be pre-populated for the user giving them the option to modify it, or continue to the next step.

Security:

In addition to only providing the user with a list of FormGroups to which they have rights, the security architecture also allows each individual question to have security access rights assigned to it. In this case, the user should not be shown questions to which they have no rights, to include in their data set. Since the Security component is still being designed, the details of this are not known yet.

Properties:

DataSetId—A unique number identifying this data set.

DataSetTypeId—The type of data contained in this data set.

1 Matrix (Product Information)

2 Company Information

3 User information

Name—A user defined name for this data set.

UID—The UID of the user that created this data set.

NewDataRule—A number representing how new data should be handled.

1 All new Core data should be automatically included in the data set.

2 New Core data should not be automatically included in the data set.

3 Notify user when new data has been added so they can decide.

MetaDataRule—A number representing how meta data should be handled.

1 Automatically include all meta data.

2 Do not include any meta data.

3 User will decide on a by question basis.

CreatedDTS—Timestamp when the data set was created.

LastModifiedDTS—Timestamp when the data set was last modified.

FormGroupId—The FormGroupId(s) to be included in the data set.

FormQuestionId—The FormQuestionId(s) to be included in the data set.

Methods:

Add—Saves the new data set to the database.

Update—Modifies an existing data set.

Delete—Deletes an existing data set.

SaveAs—Makes a copy of an existing data set.

Tables: (The DataSet tables are to be used as a starting point, but can be modified as necessary. All other tables are used by other components and should not be modified without prior approval.)

DataSets—Contains information common to the whole data set.

DataSetDetails—Contains detailed information about the data set.

DataSetTypes—Contains the available types of data sets that can be created.

FormGroup—Contains information about the FormGroup.

FormGroupDetails—Contains information about each Form in the FormGroup.

FormQuestion—Contains information about each Question on a Form.

Answer—Contains information about the answers to each question.

Security Tables—To be determined.

Core_Int—Core data table containing integer data types.

Core_Text—Core data table containing text data types.

Core Varchar—Core data table containing varchar data types.

MetaData—Contains additional information about each record in the Core tables that is not included as a part of the FormGroup. Currently, this will be used for storing the challenges and responses for answers to a particular question, but in the future may contain any type of meta data about the core data.

Table Definitions:

| | | |
|---|---|---|
| DataSets | | |
| DataSetId | int | An identity field containing a unique number for each Data Set |
| DataSetTypeId | int | A number representing the type of Data Set |
| Name | varchar | A user specified name for this Data Set |
| UID | int | The UID of the user that created this Data Set |
| CreatedDTS | datetime | Timestamp when the Data Set was created |
| LastAccessDTS | datetime | Timestamp when the Data Set was last modified |
| NewDataRule | tinyint | Determines whether or not new data should be included in the data set. |
| DataSetDetails | | |
| DataSetId | int | A unique number representing this Data Set. |
| SeqNum | int | A counter identifying the order in which the data should be extracted |
| FormGroupId | int | The FormGroupid associated with this data |
| FormId | int | The FormId associated with this data |
| FormQuestionId | int | The Question associated with this data |
| MetaData | bit | Identifies whether or not meta data should also be extracted |
| DataSetTypes | | |
| DataSetTypeId | int | An identity field containing a unique number for each Data Set Type |
| Name | varchar | The name of this Data Set Type |
| FormGroup | | |
| GroupId | int | An identity field containing a unique number for each Form |
| | | Group |
| IndustryId | int | Number representing the industry this Form Group belongs to |
| ProductCategoryId | int | Number representing the Product Category this Form Group |
| | | belongs to |
| Category | varchar | The category this Form Group belongs to |
| FormGroupName | varchar | The name of this Form Group |
| CreatedDTS | datetime | Timestamp this Form Group was created |
| ModifiedDTS | datetime | Timestamp this Form Group was last modified |
| Author | varchar | Person who created this Form Group |
| FormGroupDetails | | |
| GroupId | int | Number relating to the parent Form Group |
| DisplayOrder | int | Order this form is displayed |
| FormId | int | Number relating to the parent Form |
| Redirect | varchar | URL the user is redirected to after completing this form |
| FormQuestion | | |
| FormQuestionId | int | An identity field containing a unique number for each Form |
| | | Question |
| FormId | int | Number relating to the parent Form |
| QuestionNum | smallint | Number of this question |
| QuestionText | varchar | Text of this question |
| Location | varchar | Location this question is placed on the form |
| InputType | tinyint | Type of input used on the form |
| TemplateId | int | Number relating to the parent Template |
| Answer | | |
| FormId | int | Number relating to the parent Form |
| QuestionNum | smallint | Number of this question |
| AnswerSort | tinyint | Order the answer is displayed on the form |
| InputId | int | Number relating to the parent Input |
| AnswerValue | varchar | Value used to populate results (multiple choice) |
| AnswerText | varchar | Text provided for answer (multiple choice) |
| GetFromDB | bit | True if answer choices come from database |
| AllowEdit | bit | True if answer can be edited |
| SaveToDB | bit | True if answer should be written to database |
| SPName | varchar | Stored procedure used if choices come from database |
| TableName | varchar | Table where answers are written |
| FormQuestionId | int | Number relating to the parent FormQuestion |
| Core_IntID | int | An identity field containing a unique number for each record in this table |
| SessionId | int | A number representing information about who inserted this data |
| FormId | int | A number representing the FormId that this information came from |
| DataTypeId | int | A number representing the type of data contained in this record |
| QuestionNum | smallint | The question number for this record |
| | | A counter for multiple choice questions where more than one answer can be |
| AnswerSort | tinyint | selected. |
| Value | int | The information submitted by the user for this question |
| Core_TextID | int | An identity field containing a unique number for each record in this table |
| SessionId | int | A number representing information about who inserted this data |
| FormId | int | A number representing the FormId that this information came from |
| DataTypeId | int | A number representing the type of data contained in this record |
| QuestionNum | smallint | The question number for this record |
| | | A counter for multiple choice questions where more than one answer can be |
| AnswerSort | tinyint | selected. |
| Value | text | The information submitted by the user for this question |
| Core_VarcharID | int | An identity field containing a unique number for each record in this table |
| SessionId | int | A number representing information about who inserted this data |
| FormId | int | A number representing the FormId that this information came from |
| DataTypeId | int | A number representing the type of data contained in this record |
| QuestionNum | smallint | The question number for this record |
| | | A counter for multiple choice questions where more than one answer can be |
| AnswerSort | tinyint | selected. |
| Value | varchar | The information submitted by the user for this question |
| MetaData | | |
| MetaDataId | int | An identity field containing a unique number for each MetaData record |
| UID | int | Person who created this MetaData |
| SeqNum | smallint | Counter for each record included in this MetaData |
| CoreTableId | tinyint | Number representing the Core data table this MetaData applies to |
| | | Number representing the record in the Core data table this MetaData |
| CoreId | int | applies to |
| MetaDescId | smallint | Number representing the type of MetaData this is |
| ParentId | int | Number representing the parent MetaData record. |
| Value | varchar | Value of this MetaData |

### Full Text Search Component

Description: Allows the full-text searching of core data.

Properties:
UserId
DataType
Keywords

### Configure Header/Footer

Description: This component is responsible for collecting and storing all the configuration information necessary to define a Header and/or Footer to be included in ASP files.

Properties:

HeaderId

FooterId

Header

Footer

Methods:

Add

Update

Delete

SaveAs

### Hierarchy Editor Component

Description: Allows for the creation and editing of industry/product/service hierarchies. These hierarchies can be industry standards or unique hierarchies created by mBLAST or end users.

Properties:

UserId

HierarchyId

HierarchyType

### Hierarchy Generator Component

Description: Given a HierarchyId, the Hierarchy Generator will create a dataset in a hierarchical fashion and allow input/output functionality in association with the generated hierarchy. Also includes search functionality for finding categories within the generated hierarchy.

Properties:

UserId

HierarchyId

HierarchyType

Keywords

### Hosted Page Component

Description: Allows the user to configure hosted pages.

Properties:

UserId

ConfigurationId

PresentationId

LocationId

### Notification Engine

Description: This component is responsible for notifying companies of changes made to the data.

Properties:

CompanyId

NotificationMethod

GroupId

Public Enum: Used for NotificationMethod.

EMAIL = 1
WORKSPACE = 2
FAX = 3
DATA_PUSH = 4

My Notes:

Notification Engine Capabilities

Matrix Tracking—monitors status of saved matrices and notifies user in the workspace of changes to saves matrices.

Survey Tracking—monitors status of surveys and notifies user in the workspace of the number of companies that have filled out a survey

Hosted Page Tracking—monitors changes to data in hosted pages and generates new pages on an agent-specified schedule

Data Feed Tracking—monitors changes to data in data sets with notification agents and generates new data feeds on agent-specified schedule.

Delta Data Agent

The Delta Data Agent is responsible for tracking changes to a data set. The following data sets can be tracked by a Delta Data Agent:

Saved Matrix

Survey

Hosted Presentation

Data Feed

Product Categories

Companies

Everything that is to be tracked by a Delta Data Agent must be first saved as a Data Set. For example, if a user is interested in tracking changes about a particular company, then a Data Set that references that company's data is saved, and the Delta Data Agent is based on that Data Set.

A Survey has a Data Set defined for it when it is created, and this Data Set can be tracked just like any other. The creation of a Survey also creates a Delta Data Agent to track additions to Survey Data Set. The user is notified of additions to Survey data via email and through a notification message located on the front page of the user's workspace

### Configure Presentation

Description: This component is responsible for collecting and storing all the configuration information necessary to define how specific HTML pages are displayed.

Properties:

TemplateId

Header

Footer

Methods:

Add

Update

Delete

SaveAs

### Schedule Component

Description: This component will consist of an ASP interface, and one or more COM components. It is responsible for collecting the necessary information needed to schedule pre-defined tasks and store the information for those tasks in the database.

Technical Details: The ASP interface should contain the minimum amount of business logic possible, and should not interact directly with the database. The COM component (mBSchedule.dll) should contain all the necessary business logic and database interaction required to configure a set of scheduled tasks. Whenever possible, embedded SQL should be avoided and stored procedures should be used.

Process: The user will be presented with a list of Tasks pre-defined by mBLAST administrators. The user may select one or more of these tasks and have them scheduled to run on a periodic basis. Each Task will have a related component built to carry out that task.

Properties:

UID _The UserId of the person creating or modifying this schedule or task.

Scheduleld—The Schedule to be created or modified.

TaskId—The Task to be created or modified.

ComponentId _The component used to carry out this Task.

ComponentItemId—The parameter to be supplied to this component.

Value—The value of the parameter to be supplied to this component.

Interval—The interval, in minutes, until the Schedule will run again.

Status—The completion status of this Schedule.

CreatedDTS—Timestamp when this Schedule was created.

Methods:

AddSchedule—Inserts a new record into the Schedule table.

UpdateSchedule—Modifies a record in the Schedule table.

DeleteSchedule—Deletes a record from the Schedule table.

SaveScheduleAs—Makes a copy of an existing Schedule with a new name.

AddScheduleDetail—Inserts a new record into the ScheduleDetails table.

UpdateScheduleDetail—Modifies a record in the ScheduleDetails table.

DeleteScheduleDetail—Deletes a record from the ScheduleDetails table.

SaveScheduleDetailAs—Makes a copy of an existing ScheduleDetail with a new name.

AddTask—Inserts a new record into the ScheduleTasks table.

UpdateTask—Modifies a record in the ScheduleTasks table.

DeleteTask—Deletes a record from the ScheduleTasks table.

SaveTaskAs—Makes a copy of an existing Task with a new name.

AddComponent—Inserts a new record into the Components table.

UpdateComponent—Modifies a record in the Components table.

DeleteComponent—Deletes a record from the Components table.

SaveComponentAs—Makes a copy of an existing Component with a new name.

AddComponentItem—Inserts a new record into the ComponentItems table.

UpdateComponentItem—Modifies a record in the ComponentItems table.

DeleteComponentItem—Deletes a record from the ComponentItems table.

SaveComponentItemAs—Makes a copy of an existing ComponentItem with a new name.

Tables:

| | |
|---|---|
| Schedule - | Contains the main schedule information. |
| ScheduleTasks - | Contains the tasks that may be scheduled. |
| ScheduleDetails - | Contains all the tasks belonging to a given |
| | Schedule. |
| ScheduleLog - | Contains a log of the success/failure and |
| | duration of each scheduled task. |
| Components - | Contains the components that are ran by |
| | each task. |
| ComponentParameters - | Contains the names of the parameters for |
| | each component. |
| ComponentTaskParameters - | Contains the values of the parameters for |
| | each component for each task. |

Table Definitions:

| | | |
|---|---|---|
| Schedule | | |
| ScheduledID | int | An identity field containing a unique number for each schedule |
| Name | varchar | The name of this schedule |
| UID | int | The UID of the user that created this Include File |
| Interval | int | Number of minutes until schedule should run again |
| Status | int | Completion status of the entire schedule |
| | | 0 = New, 1 = In Process, 2 = Complete, 3 = Error |
| CreatedDTS | datetime | Timestamp when the schedule was created |
| LastRanDTS | datetime | Timestamp when the schedule was last ran |
| ScheduleTasks | | |
| TaskId | int | An identity field containing a unique number for each Task |
| Name | varchar | The name of this Task |
| ComponentId | smallint | Number representing the component that will execute this Task |
| ScheduleDetails | | |
| TaskId | int | An identity field containing a unique number for each Task |
| Name | varchar | The name of this Task |
| ComponentId | smallint | Number representing the component that will execute this Task |
| ScheduleLog | | |
| TaskId | int | An identity field containing a unique number for each Task |
| Name | varchar | The name of this Task |
| ComponentId | smallint | Number representing the component that will execute this Task |
| Components | | |
| TaskId | int | An identity field containing a unique number for each Task |
| Name | varchar | The name of this Task |
| ComponentId | smallint | Number representing the component that will execute this Task |
| ComponentParameters | | |
| TaskId | int | An identity field containing a unique number for each Task |
| Name | varchar | The name of this Task |
| ComponentId | smallint | Number representing the component that will execute this Task |
| ComponentTaskParameters | | |
| TaskId | int | An identity field containing a unique number for each Task |
| Name | varchar | The name of this Task |
| ComponentId | smallint | Number representing the component that will execute this Task |

### Survey Component

Description: Uses the same components as the Form Editor/Generator with modifications to the interface for ease of use by the end user. Also requires a new FormGroup type “Survey”.

Properties:

UserId

FormGroupId

### Create Template

Description: This component is responsible for collecting and storing all the configuration information necessary to define a template to be used when displaying HTML pages.

Properties:

Various HTML Properties (Font, Background, Colors, . . . )

Methods:

Add

Update

Delete

SaveAs

### Upload Component

Description: This component will be used in conjunction with the SA FileUp component to handles browser based file uploads. Currently it will be used only for uploading different media types, but in the future, may be used for uploading small data files, or other types of files.

Technical Details: This component will consist of an ASP interface in the form of an include file, and a COM component (mBUpload). The include file should be used whenever an ASP form uses an Input Type of “File”. The include file will be responsible for calling the SA FileUp component as well as the mBUpload component. The include file should have the minimum amount of business logic necessary, and should not have any interaction with the database. The COM component will contain all the business logic, and will perform any required database activity.

Process: When the upload type is media, the user will supply the FileName, MediaType. The FileType will be determined by the file extension, and the user will validate the extension if it does not already exist in the FileTypes table. A MediaDirectory field will be added to the Company table, and that directory will be used to store all Media files for that company.

If the FileName provided by the user already exists, the user should be given the option to overwrite the file, or provide an alternative name.

The mBUpload component will set the appropriate directory for the SA FileUp component, and it will be responsible for copying the Media file to that directory. Upon successful upload, the mBUpload component will write the necessary information to the Media table.

Users may also choose to upload their Media files in a compressed format, consisting of one or more Media files. If so, the mBUpload component should prompt the user for the required action should there be duplicate FileNames. The component should extract the file in the appropriate directory, and write a record to the Media table for each file. Note: SA FileUp is part of ASPstudio. ASPstudio also includes a component (SA Archive) that can be used for compressing and extracting zip files.

Additional specs will be provided before this component will be used for any UploadType other than Media.

Properties:

UID—The person uploading the file.

Cold—The company associated with the file.

Directory—The directory where the file should be written.

FileName—The name of the file.

MediaType—The type of Media (Logo, Product Info, Product Image, etc.)

FileType—The type of file (.doc, .pdf, .gif, jpg, etc.)

UploadType—Number representing the Upload type. Currently it will be set to 1, indicating the upload type is Media, and information should be written to the Media table.

Methods:

Add—Inserts a new record into the Media table.

Update—Modifies an existing record in the Media table.

Delete—Deletes a record from the Media table.

AddMediaType—Inserts a new media type into the MediaTypes table.

UpdateMediaType—Modifies an existing record in the MediaTypes table.

DeleteMediaType—Deletes a record from the MediaTypes table.

AddFileType—Inserts a new record into the FileTypes table.

UpdateFileType—Modifies an existing record in the FileTypes table.

DeleteFileType—Deletes a record from the FileTypes table.

Tables:
(These tables should be used as a starting point. No other
programs within mBlast currently use these tables, so they may be
modified as necessary.)

| | |
|---|---|
| Media - | Main table where information about the uploaded |
| | media is stored. |
| MediaTypes - | Table containing different media types. (Logo, Product |
| | Image, Product Specs, etc.) |
| FileTypes - | Table containing different file types. |
| | (.doc, .pdf, .gif, .jpg, etc.) |

Table Definitions:

| | | |
|---|---|---|
| Media | | |
| MediaId | int | An identity field containing a unique number |
| | | for each Media record |
| UID | int | Person who uploaded this Media |
| Cold | int | Company this Media is associated with |
| Directory | varchar | Directory where this Media is located |
| FileName | varchar | File name of this Media |
| FileTypeId | tinyint | File type of this Media |
| MediaTypeId | smallint | Type of Media |
| MediaTypes | | |
| MediaTypeId | tinyint | An identity field containing a unique number |
| | | for each Media Type |
| Name | varchar | Name of this Media Type |
| FileTypes | | |
| FileTypeId | tinyint | An identity field containing a unique number |
| | | for each File Type |
| Name | varchar | Name of this File Type |

### Create Data Set Component

Description: This component is responsible for collecting and storing all the configuration information necessary to define a data set.

Properties:

PresentationType

GroupId

Public Enum: Used for Presentation Type.
BUYERS_GUIDE = 1
COMPANY_PROFILE = 2
LINK_LIST = 3
GLOSSARY = 4

### Create Presentation Component

Description: This component is responsible for collecting and storing all the configuration information necessary to define how specific HTML pages are displayed.

Properties:

TemplateId

Header

Footer

### Data Packager Component

Description: This component is responsible for retrieving data from the Core tables and formatting the data into the user specified type.

Properties:

ConfigurationId

Format

CompressionType

EncryptionType

OutputPath

Public Enum: Used for Format.
FORM_COMMA = 1
FORM_TAB = 2
FORM_EXCEL = 3
FORM_ACCESS = 4
FORM_XML = 5
FORM_HTML = 6
FORM_ROSETTANET = 7
Public Enum: Used for CompressionType.
COMP_NONE = 0
COMP_ZIP = 1
COMP_TAR = 2
Public Enum: Used for EncryptionType
ENC_NONE = 0
ENC_PGP = 1

### Delivery Engine Component

Description: This component is responsible for delivering changed data.

Properties:

CompanyId

UserId

EmailAddress

Url

FileName

DeliveryType

FaxNumber

Public Enum: Used for NotificationMethod.
EMAIL = 1
FTP = 2
FAX = 3

### Notification Engine Component

Description: This component is responsible for querying the Core data at predetermined intervals and notifying companies of changes made to the data.

Properties:

CompanyId

Interval

NotificationMethod

GroupId

Public Enum: Used for NotificationMethod.
EMAIL = 1
WORKSPACE = 2
FAX = 3
DATA_PUSH = 4

Tools

Data Presentation—Basic User

The Data Presentation tool is available in two versions for different users. The Power-user version has much better control over every aspect of the process, from creating the data set to assigning a class, and proprietary templates and includes.

The Basic-user version is a simplified interface that allows users to quickly and easily create a basic presentation. There are two methods for the Basic user to create a presentation: a presentation wizard, and a hierarchy selector.

Using the Presentation Wizard, the user has several options for creating a presentation. The user can select the class type, and the user can select formatting options, if any, for that class. First the user selects a single product category from a hierarchy, which becomes the default data set to use with the presentation. This data set is used behind the scenes and never explicitly saved or named by the user. Next the user selects the class/presentation type from a list of options. The last page allows the user to configure specific formatting options for the selected presentation type. Once the presentation has been generated he user can use the basic Presentation edit controls to filter fields/products displayed, and can use the save button to save a specific Presentation configuration with a name, available from the user's workspace.

Using the hierarchy selector option, the user selects a single product category from a hierarchy, which becomes the default data set to use with the presentation. This data set is used behind the scenes and never explicitly saved or named by the user. Once the product category has been chosen, and the data set generated for the user, a standard Matrix presentation is generated for the user automatically and displayed on the screen. The user can use the basic Matrix edit controls to filter fields/products displayed, and can use the save button to save a specific Matrix configuration with a name, available from the user's workspace.

Matrix Generator

The Matrix Generator is a tool that allows the end user to create a table of information, save the configuration, create new features for products and invite companies to enter their product values in the new feature fields, and track information in the matrix as it is changed by companies. The Matrix also allows user to challenge values entered by companies about their products and allows those companies to respond to challenges, and allows companies to attach marketing information to individual data units.

Steps to create a matrix:

1. Select a Product/Service/Company from hierarchy—this will drive the content of the Matrix—mblast.telechoice.com/matrix_new2.htm

2. Select the UI display properties of the matrix—mblast.telechoice.com/matrix_new5.htm

3. Matrix Edit page allows the selection of the companies and product features to include—Then select View Matrix to display the finished matrix with data included—mblast.telechoice.com/matrix_edit.htm

Once a matrix has been created, most other features are driven from the matrix presentation itself. There are many options within the matrix view:

Features:

View Matrix—Generate and display matrix based on user criteria

Save Matrix—Save Matrix for user—add to Workspace

Email Companies—Generate an email form with all the company contacts in a list box—user can select or de-select any and all company contacts to send an email to

Edit Matrix—change the companies and product features show, also change the UI display features

Group Checked Items—Feature of Edit Matrix—allow two or more columns to be grouped into one column

Add a Column—Feature of Edit Matrix—allow the user to create user-specific column and enter their own data, or invite companies to enter their own answers—similar functionality to the survey.

Delete Matrix—Delete

Download Matrix—Package the matrix in a downloadable format i.e. zip file of spreadsheet or html file

Transpose Matrix—switch the matrix so the columns become rows and vice versa

Best In Class—allows a user to specify the “best answer” to each product feature question for a given product. This will generate a new matrix with the “best answers” listed across the top of the matrix and highlights each best answer in the matrix by turning the cell light blue—see mblast.telechoice.com/matrix-bic01.htm

Switch to Flat Matrix—Display all features in non-tabbed display, include top level categories

Hide Logos—remove logo columns

Hide Product Images—Remove product image columns

Hide Challenges—remove challenge icons

Hide Updates—remove update color coding from recently changed records

Challenge/Response—Challenge/Response allows a discussion about an individual data unit to be attached to that unit. A user (vendor, reporter, etc.) has the ability to “challenge” a particular product data unit. When this challenge is posed, a “challenge logo” will indicate that a challenge to the record has been made. This icon is different depending on who is viewing the matrix, whether the user is the person who created the challenge or any other user. By clicking on this icon anyone can see the challenge that was entered in a pop-up box. Also, once the challenge is made, the company that is being challenged will be notified by email and will have the opportunity to change the value and/or respond to the challenge. Once the challenge has been responded to, the challenge icon changes to an icon that indicates that “challenge has been answered”. This icon is different depending on who is viewing the matrix, whether the user is the person who created the challenge or any other user. By clicking on this icon, the end user will be able to see the challenge and response in a pop-up box.

Positioning Statements—Positioning statements allow a company to include extra information about a product feature. This allows them to differentiate their product from competitors. They are limited in the number of positioning statements they can include on one product

Pop-up Descriptions/Challenge+Responses/Postioning Statements—All Meta data associated with the core data in the matrixes is presented through a pop-up window

Delta Data Notification—by email and by colored cell—There are two types of notifications available within the framework of the Matrix. The Matrix will automatically identify any data units that have been updated within a defined period of time (currently decided upon date =2 weeks) by setting the color of that table cell to yellow. Also, the user who creates the matrix can select to be notified by email whenever a data unit changes.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

I claim:

1. A method for collecting marketing information collateral data in all electronic forms, said method comprising the steps of:
inputting the data;
managing the content of the data;
editing the data; and
controlling the dissemination of the data to the public.
